(19) United States
(12) Patent Application Publication
(10) Pub. No.: US 2026/0276868 A1
(43) Pub. Date: Sep. 17, 2026

(54) EYEWEAR WITH BLUE-LIGHT BLOCKING AND ANTI-FOG COATING

(71) Applicant: Zenni Optical, Inc., Novato, CA (US)

(72) Inventors: Steven LEE, Barrington, IL (US); Julia ZHEN, Novato, CA (US); Feng LIU, Zhenjiang (CN); Xule CHEN, Zhenjiang (CN); Liangliang Mao, Zhenjiang (CN)

(21) Appl. No.: 19/563,876

(22) Filed: Mar. 11, 2026

Related U.S. Application Data
(60) Provisional application No. 63/770,318, filed on Mar. 11, 2025.

(51) Int. Cl. G02B 1/115; G02B 1/04; G02B 1/12; G02B 1/14; G02B 1/18; G02C 7/10

(52) U.S. Cl. CPC G02B 1/115; G02B 1/041; G02B 1/12; G02B 1/14; G02B 1/18; G02C 7/107

(57) ABSTRACT

Eyeglass lenses can limit blue light exposure and the formation of fog. The lenses can be made up of various coatings applied to resin lenses. Optionally, the coatings can include one or more of a hard coating, anti-reflection coating, anti-fog coating, and hydrophobic coating. The hard coating can be dip coated onto the resin lenses, and the anti-reflection coating can be vacuum coated onto the hard coatings. The anti-reflection coating can be a layered structure including one or more of SiO₂, ZrO₂, TiO₂, Al₂O₃, and ITO. Different coatings can be applied in various combinations and thicknesses to create lenses with different effects. For example, the lenses can reflect harmful blue light and prevent fog from forming on the lens, both without obstructing the wearer's vision.

### CROSS REFERENCE TO RELATED APPLICATIONS

This application claims priority under 35 U.S.C. 119 (e) to, and the benefit of, U.S. Provisional Application No. 63/770,318, filed Mar. 11, 2025, the entirety of which is incorporated herein by reference.

### BACKGROUND

### Field of the Inventions

The present disclosure relates to eyewear, and more specifically, to improved lens technology that can provide reduced blue light exposure and resistance to fogging.

### Description of the Related Art

The use of eyewear that adapts to different environmental and lighting conditions has become increasingly common, providing enhanced comfort and utility for users in their daily lives. Advances in lens technologies, such as photochromic and polarized lenses, have made it possible for eyewear to offer improved performance by adjusting to varying light levels or reducing glare. These features have expanded the applications of eyewear beyond basic vision correction, making them integral tools for a wide range of activities and environments.

Despite these advancements, developing eyewear that effectively meets the demands of everyday life presents significant challenges. Factors such as temperature fluctuations, which can affect lens clarity and material performance, and specific scenarios like driving, where rapid light adjustments are critical, add complexity to the design process. Ensuring that eyewear remains comfortable, durable, and reliable across diverse conditions requires a careful balance of innovation, material science, and user-centered design.

### SUMMARY

In accordance with at least some embodiments disclosed herein is the realization that people are constantly exposed to harmful blue light from their smart phone screens, laptop screens, and television screens—among other sources of blue light. Blue light is a type of light with a very high energy—especially in the wavelength range of 400 nm to 455 nm—that is commonly generated by light-emitting diodes used in devices such as smart phones and laptops. Constant exposure to blue light can cause the retinal epithelial pigment cells to die, leading to cell death in the photosensitive area, macular degeneration, fundus lesions, decreased vision, and even blindness. In fact, according to the World Health Organization Eye Care Association, more than 30,000 people worldwide go blind every year due to blue light and radiation. Furthermore, blue light stimulates the brain, inhibits melatonin secretion, and increases the production of adrenal cortex hormones, all of which impact physiological factors such as heart rate, alertness, sleep patterns, body temperature, gene expression. These impacts disrupt the body's physiological rhythm and increase the risk of disease.

The conventional approach to protecting people's eyes from blue light exposure is wearing glasses with dark yellow lenses. However, glasses with dark yellow lenses lead people to see everything with a yellow tint. Additionally, studies have shown that long-term excessive exposure to yellow light can cause irritation to the cornea, resulting in blurred vision in patients. Some patients may also experience swelling and burning sensations in the eye area, which can also lead to visual fatigue.

Moreover, in accordance with at least some embodiments disclosed herein is the realization that eyeglass lenses often become fogged up and can block vision, usually due to condensation. Condensation can fog up eyeglass lenses when a wearer of the eyeglasses drinks hot coffee, cooks dinner, or even enters a warm room after being outside in the cold. For healthcare professionals, or even laypersons during a health crisis, eyeglasses can fog up when they are worn with medical masks. Fog on eyeglass lenses is inconvenient, and sometimes even dangerous (e.g., when the wearer is driving or performing surgery). To make matters worse, clearing up the fog is difficult. While the condensation will naturally evaporate eventually, that takes time, which makes this solution increasingly inconvenient as people adopt quicker-paced lifestyles. Wiping away the condensation also is not a good solution because wiping often results in streaking, which also makes it hard to see out of eyeglasses.

Conventional attempts at preventing eyeglasses from fogging up consist of an anti-fog spray and a cloth. Wearers can apply the anti-fog spray to their lenses and rub the anti-fog spray into the lenses with a cloth. However, in accordance with at least some embodiments disclosed herein is the realization that the anti-fog spray is only effective for approximately four to five days, which means this solution requires constant, cumbersome maintenance. Additionally, wearers must pay the cost of the anti-fog spray repeatedly, which becomes expensive over time. An alternative conventional solution to fogged up lenses are anti-fog lenses. However, existing anti-fog lenses generally cannot maintain the anti-fog effect over extended periods of use. Moreover, most of the existing anti-fog lenses have very low surface hardness, making them prone to damage when the eyeglasses are worn consistently.

In accordance with at least some embodiments disclosed herein is the realization that blue light exposure and lens fogging can be limited by eyewear with a layered structure made up of a resin lens with a hardened coating, a vacuum coated anti-reflection coating, a thermal-evaporated hydrophobic coating, and a thermal-evaporated anti-fog coating.

For example, some embodiments provide eyewear (such as glasses, goggles, or other eyewear) that can comprise an anti-reflection layer or coating that is effective to mitigate the harmful effects of blue light and an anti-fog coating in combination therewith.

The present disclosure addresses these and other challenges by providing innovative systems, methods, and devices that each have several innovative and beneficial aspects, no single one of which is solely responsible for the desirable attributes disclosed herein.

The systems, methods, and devices of this disclosure each have several innovative aspects, no single one of which is solely responsible for the desirable attributes disclosed herein.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology. The disclosure of U.S. Provisional Application No. 63/574,901, filed on Jun. 13, 2024, is incorporated by reference herein, in its entirety.

### BRIEF DESCRIPTION OF THE FIGURES

Various features of illustrative embodiments of the inventions are described below with reference to the drawings. The illustrated embodiments are intended to illustrate, but not to limit, the inventions. The drawings contain the following figures:

FIG. 1 illustrates an exploded view of the layers that constitute the layered structure of an eyeglass lens that limits blue light exposure, according to some embodiments of the present disclosure.

FIG. 2 illustrates the spectrum of radiation that is transmitted by some embodiments of the blue-light-reflecting eyeglass lens, according to some embodiments of the present disclosure.

FIG. 3 illustrates the spectrum of radiation that is transmitted by another embodiment of the blue-light-reflecting eyeglass lens, according to some embodiments of the present disclosure.

FIG. 4 illustrates an exploded view of the layers that constitute the layered structure of an anti-fog eyeglass lens, according to some embodiments of the present disclosure.

FIG. 5 illustrates a cross-sectional view of a first embodiment of the layered structure of an anti-fog eyeglass lens, according to some embodiments of the present disclosure.

FIG. 6 illustrates an exploded view of the layers that constitute the layered structure of a first embodiment of an eyeglass lens that limits blue light exposure and the formation of fog, according to some embodiments of the present disclosure.

FIG. 7 illustrates an exploded view of the layers that constitute the layered structure of a second embodiment of an eyeglass lens that limits blue light exposure and the formation of fog, according to some embodiments of the present disclosure.

FIG. 8 illustrates an exploded view of the layers that constitute the layered structure of a third embodiment of an eyeglass lens that limits blue light exposure and the formation of fog, according to some embodiments of the present disclosure.

### DETAILED DESCRIPTION

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

### Blue-Light-Blocking Lenses

In accordance with at least some embodiments disclosed herein is the realization that people's eyes are constantly exposed to harsh blue light, but existing eyeglasses do not properly protect people's eyes from blue light. Constant exposure to blue light causes vision fatigue and optical health problems. Existing eyeglasses that are designed for blue light protection often reflect more visible light than just the harmful blue light, which impairs the wearer's vision. Furthermore, existing eyeglasses for blue light protection have low surface hardness, which means that the eyeglasses lack durability and are likely to break in response to repeated use.

Some embodiments of the present disclosure provide eyewear (such as glasses, goggles, or other eyewear) that can comprise an anti-reflection layer or coating that is effective to mitigate the harmful effects of blue light. Optionally, some embodiments can provide eyewear that also comprises an anti-fog coating in combination therewith. Optionally, such embodiments can include a tinting layer that enhances the color contrast perceived by the wearer.

Some embodiments of the present disclosure provide for a blue-light-reflecting eyeglass lens configured to limit blue light exposure and the harmful effects of blue light exposure. Specifically, the lenses described herein are configured to reflect light with a wavelength between about 400 nm and about 455 nm (i.e., harmful blue light). Optionally, the lenses can reflect harmful blue light with a wavelength between about 395 nm and about 460 nm or with a wavelength between about 405 nm and about 450 nm. The lenses can reflect at least about 53% of harmful blue light with a wavelength between about 400 nm and about 455 nm. Optionally, the lenses can reflect about 30%, about 50%, or about 52% of harmful blue light with a wavelength between about 400 nm and about 455 nm.

At the same time, the blue-light-reflecting lenses are configured to transmit visible blue light with a wavelength between about 455 nm and about 500 nm. Optionally, the lenses can transmit visible blue light with a wavelength between about 450 nm and about 505 nm or with a wavelength between about 450 nm and about 495 nm.

In some embodiments, the lenses can transmit at least about 90% of light with a wavelength between about 400 nm and about 500 nm. Optionally, the lenses can transmit about 77% or 97% of light with a wavelength between about 400 nm and about 500 nm.

In other embodiments, the lenses can transmit non-harmful, visible light with a wavelength between about 380 nm and about 780 nm. Optionally, the lenses can transmit about 90%, about 93%, or about 95% of light with a wavelength between about 380 nm and about 780 nm.

The blue-light-reflecting lenses are also configured to transmit light at a wavelength of about 585 nm (i.e., yellow visible light). Specifically, the lenses can transmit about 98% of yellow visible light with a wavelength of about 585 nm. Optionally, the lenses can transmit about 83%, about 84%, or about 96% of light with a wavelength of about 585 nm.

The blue-light-reflecting lenses are also configured to absorb light with a wavelength of about 585 nm. Optionally, the lenses can absorb light with a wavelength between about 580 nm and about 590 nm. In some embodiments, the lens is configured to absorb at least about 5% to 25% of light with a wavelength of about 585 nm. Optionally, the lens is configured to absorb at least about 10% to 20% of light with a wavelength of about 585 nm.

The eyeglass lenses described herein are designed to be blue-light-reflecting and have only a slightly yellow tint that is evenly distributed across the lens. The lenses can have a surface hardness of at least ~5 H, which effectively limits the impact of surface scratches on the blue-light-reflecting lens. In some embodiments, the blue-light-reflecting lenses can have a surface hardness of at least ~7 H. Moreover, the blue-light-reflecting lens can be ultra-hydrophobic (with a water drop angle of at least 115°, compared to an ordinary water drop angle of 107°), which effectively prevents fog and fingerprints from forming on the lens and obstructing the wearer's field of vision.

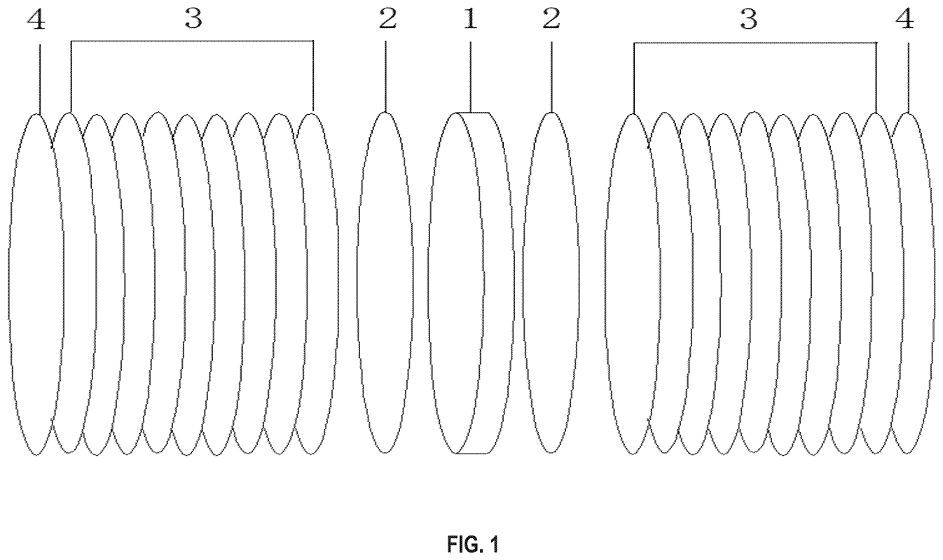

FIG. 1 illustrates an exploded view of the layers that constitute the layered structure of an eyeglass lens that limits blue light exposure, according to some embodiments of the present disclosure. In particular, FIG. 1 shows a coating structure that is symmetrical about a resin lens 1. While conventional blue-light-reflecting lenses often distort the wearer's vision, the symmetrical coating around the resin lens can reduces the distortive effect of blue-light reflecting lenses disclosed herein. Moreover, the symmetrical coating structure ensures consistent optical performance of the lenses in both directions. Both sides of the resin lens 1 are coated with a hard coating 2 (or hardened layer). Similarly, each hard coating 2 is coated with an anti-reflection coating 3, which is a nine-layer structure that includes a first SiO2 layer, a first ZrO2 layer, a second SiO2 layer, a second ZrO2 layer, a third SiO2 layer, a third ZrO₂ layer, a first ITO layer, a first Al2O3 layer, and a fourth SiO2 layer. The first SiO2 layer is adjacent to the hard coating 2, and the fourth SiO2 layer is adjacent to a hydrophobic coating 4. Each of these coatings is described in greater detail below.

The resin lens is a flat structure with two opposite sides (i.e., a front side and a back side). The two opposite sides can be referred to as the first surface and the second surface.

In some embodiments, the resin lens can be a blue light blocking resin lens. Optionally, the resin lens can be a blue-light-blocking resin lens with an absorber. In some embodiments, the blue-light-blocking resin lens with an absorber can be configured to absorb light with a wavelength between about 570 nm and about 600 nm, with a wavelength between about 580 nm and about 590 nm, or with a wavelength of about 585 nm. These wavelength ranges target yellow light. As a result, the absorber can reduce the amount of yellow light that passes through the lens and reaches the wearer's eyes. Yellow light, particularly at the 585 nm wavelength, is close to the wavelength of blue light, which has been associated with eye strain, particularly when using digital devices that emit a significant amount of blue light. Filtering out yellow light at the 585 nm wavelength can reduce glare and improve visual contrast. In particular, for individuals who are sensitive to bright light or who need to discern contrast clearly (e.g., people who drive at night), filtering out yellow light can make the visual experience more comfortable and possibly improve reaction times. Moreover, some studies suggest that reflecting yellow light at the 585 nm wavelength can reduce the risk of macular generation and other forms of light-induced eye damage. In some embodiments, the resin lens can comprise about 0.001% to about 0.1% 585 nm absorber. Optionally, the resin lens can comprise about 0.05%, about 0.015%, or about 0.005% 585 nm absorber. Optionally, the resin lens can be a UV420 resin lens.

Optionally, the blue light blocking resin lens can have a refractive index between about 1.20 and about 2.00. Optionally, the blue light blocking resin lens can have a refractive index between about 1.35 and about 1.85. Optionally, the blue light blocking resin lens can have a refractive index between about 1.49 and about 1.74. Optionally, the blue light blocking resin lens can have a refractive index of approximately 1.67. Optionally, the blue light blocking resin lens can have a refractive index of approximately 1.61.

Optionally, the hard coating can be dip coated onto the first and second surfaces of the resin lens. By applying the hard coating directly to the resin lens, the resin lens becomes scratch-resistant and durable, which is essential for protecting the more sensitive anti-reflection coating. Optionally, the hard coating can be an organosilicon hard coating liquid.

In some embodiments, the hard coating can be configured to absorb light with a wavelength between about 570 nm and about 590 nm. Optionally, the hard coating can be configured to absorb light with a wavelength between about 560 nm and about 600 nm or with a wavelength of about 550 nm and about 610 nm.

An anti-reflection coating is disposed on each hard coating. The anti-reflection coating can be vacuum coated onto the resin lens and the hard coating. Optionally, the anti-reflection coating is an anti-reflection film.

The anti-reflection coating has a layered structure that includes a first SiO2 layer, a first ZrO2 layer, a second SiO2 layer, a second ZrO2 layer, a third SiO2 layer, a third ZrO₂ layer, a first ITO layer, a first Al2O3 layer, and a fourth SiO2 layer. The layered structure is arranged with the first SiO2 layer being nearest the resin lens in the fourth SiO2 layer being farthest away from the resin lens. Each layer can be arranged to provide a gradual transition of refractive indices—which is important to reduce reflection across a broader range of wavelengths, including those in the blue light spectrum—and applied at a specific thickness such that the layered structure interferes destructively with light rays in the blue portion of the visible light spectrum.

For example, alternating layers of SiO₂ and ZrO2 can minimize the reflections perceived by the wearer and reduce the brightness of glare—both of which are critical for blocking blue light without compromising the clarity of vision—because alternating layers of SiO2 and ZrO2 can create constructive and destructive interference of light waves. This is because SiO2 has a lower refractive index, while ZrO2 has a higher refractive index. This layering helps to maximize transparency and minimize glare. Moreover, the utilization of ITO and Al₂O₃ can maximize the transparency of the lens while also minimizing the reflectivity of the lens for optimal visual comfort and clarity. In particular, ITO has blue-light-blocking capabilities and placing ITO between about the other layers optimizes the interactions between about ITO, SiO2, ZrO₂, and Al2O3. This can reduce the amount of blue light transmitted through the lens while maintaining the structural integrity of the lens. Furthermore, Al2O3 can protect the lens by enhancing the hardness of the lens and increasing the scratch resistance of the lens. Finally, the fourth SiO2 layer can be positioned as the outermost part of the anti-reflection coating before the hydrophobic coating. This placement helps to create a smooth transition from the anti-reflection coating to the hydrophobic layer, ensuring minimal reflection and a consistent surface for the hydrophobic coating to adhere to.

The thickness of the layers in the layered structure varies throughout the structure. In some embodiments, the first SiO2 layer is between about 60 nm and about 110 nm thick. The first ZrO2 layer is between about 3 nm and about 65 nm thick. The second SiO2 layer is between about 15 nm and about 95 nm thick. The second ZrO₂ layer is between about 10 nm and about 145 nm thick. The third SiO2 layer is between about 8 nm and about 65 nm thick. The third ZrO2 layer is between about 35 nm and about 80 nm thick. The first ITO layer is between about 1 nm and about 15 nm thick. The first Al2O3 layer is between about 2 nm and about 18 nm thick. Finally, the fourth SiO2 layer is between about 30 nm and about 170 nm thick.

In other embodiments, the first SiO2 layer is between about 70 nm and about 100 nm thick. The first ZrO2 layer is between about 10 nm and about 55 nm thick. The second SiO2 layer is between about 25 nm and about 85 nm thick. The second ZrO2 layer is between about 30 nm and about 125 nm thick. The third SiO2 layer is between about 15 nm and about 55 nm thick. The third ZrO2 layer is between about 35 nm and about 80 nm thick. The first ITO layer is between about 3 nm and about 12 nm thick. The first Al2O3 layer is between about 5 nm and about 15 nm thick. Finally, the fourth SiO2 layer is between about 50 nm and about 150 nm thick.

Optionally, the first SiO2 layer is 95 nm thick, the first ZrO2 layer is 35 nm thick, the second SiO2 layer is 65 nm thick, the second ZrO2 layer is 110 nm thick, the third SiO2 layer is 36 nm thick, the third ZrO2 layer is 58 nm thick, the first ITO layer is 6 nm thick, the first Al2O3 layer is 10 nm thick, and the fourth SiO2 layer is 110 nm thick.

Optionally, the first SiO2 layer is 95 nm thick, the first ZrO2 layer is 45 nm thick, the second SiO2 layer is 55 nm thick, the second ZrO2 layer is 120 nm thick, the third SiO2 layer is 45 nm thick, the third ZrO2 layer is 60 nm thick, the first ITO layer is 6 nm thick, the first Al2O3 layer is 6 nm thick, and the fourth SiO2 layer is 90 nm thick.

Optionally, the first SiO2 layer is 88 nm thick, the first ZrO2 layer is 35 nm thick, the second SiO2 layer is 60 nm thick, the second ZrO2 layer is 100 nm thick, the first ITO layer is 7 nm thick, the first Al2O3 layer is 10 nm thick, and the fourth SiO2 layer is 100 nm thick. In this embodiment, the third SiO2 layer and the third ZrO2 layer are omitted from the anti-reflection coating.

A hydrophobic layer is disposed on each anti-reflection coating. The hydrophobic layer can have hydrophobic properties that can encourage water droplets on the lens (e.g., raindrops) to bead up and roll off the surface of the lens rather than spread out and form a thick layer of water that obscures the driver's vision. As a result, the ultra-hydrophobic layer can help maintain clear vision in wet conditions.

Similarly, the ultra-hydrophobic layer can repel oil and dirt, which helps wearers keep their lenses cleaner for longer and improves visibility. Additionally, lenses that stay cleaner for longer do not require frequent cleaning. Finally, because the hydrophobic layer can help keep lenses clean, the hydrophobic layer can provide the added benefit of optimizing the function of the layers beneath it, which includes the anti-reflection coating.

The hydrophobic layer, as the outermost layer, can also serve to protect the layers beneath it from abrasion and wear. Lenses are exposed to a wide range of environmental stressors, and the hydrophobic layer can extend the life of the lenses by protecting the inner layers of the lenses against these stressors while maintaining the transparency of the lenses.

In some embodiments, the hydrophobic coating has a thickness between about 5 nm and about 120 nm. Optionally, the hydrophobic coating has a thickness between about 1 nm and about 150 nm or about 3 nm and about 130 nm. Optionally, the hydrophobic coating has a thickness of about 15 nm or about 20 nm.

The present disclosure also includes methods for manufacturing an eyeglass lens that limits blue light exposure. Such a method may include providing a resin lens as previously described with respect to FIG. 1. The method may further include selecting one or more appropriate correction values and surface grinding the resin lens to apply the appropriate correction values to the resin lens. In some embodiments, the lens can be a single prescription lens. In other embodiments, the lens can be a progressive prescription lens. Optionally, the surface grinding is surface processing completed by optical design software. The method may also include wiping the resin lens, cleaning the resin lens with ultrasonic waves, and drying the resin lens.

In some embodiments of the manufacturing method, providing a resin lens includes adding 585 nm absorber to a resin base material and curing the resin base material so that the resin lens can absorb light with a wavelength between about 570 nm and about 590 nm. Optionally, the resin lens can include enough 585 nm absorber to absorb light with a wavelength between about 560 nm and about 600 nm or with a wavelength of about 550 nm and about 610 nm. Optionally, the resin lens can comprise about 0.05% to 5% 585 nm absorber. Optionally, the resin lens can comprise 0.01% to 7% 585 nm absorber or about 0.03% to 6% 585 nm absorber.

In some embodiments, after providing the resin lens, the method can include processing the resin lens to accommodate a single light level. In other embodiments, the resin lens can be processed to accommodate progressive light levels or be processed into prism lenses.

Next, hard coatings may be dip coated or spin coated onto one or both sides of the resin lens. The lifting speed for applying the hard coatings can be between about 0.5 mm/s and about 5 mm/s. Optionally, the lifting speed is between about 0.1 mm/s and about 7 mm/s or between about 0.3 mm/s and about 6 mm/s. In some embodiments, the lifting speed is about 1.8 mm/s.

In some embodiments, applying the hard coatings to one or both sides of the resin lens can comprise applying a silicone liquid to the resin lens. Optionally, the silicone liquid can be configured to absorb light with a wavelength of about 585 nm.

Optionally, the temperature of the hard coating is altered before the hard coating is applied to the resin lens.

After the hard coating is applied to the resin lens, the hard coatings can be bombarded with ions to activate the hard coatings. In some embodiments, the hard coatings are bombarded with Ar ions.

The method may further include placing the resin lens with the hardened hard coating in a vacuum coating chamber and vacuum coating anti-reflection coatings onto one or both hard coatings. Vacuum coating the anti-reflection coating onto the hard coatings may include bombarding each of the hardened layers with Ar to activate each of the hardened layers and depositing on each of the hardened layers a layered structure of SiO2, ZrO2, ITO, and Al2O3, as described above with reference to FIG. 1. The layered structure may be deposited onto the hardened layers with an electron gun. The hydrophobic coating is deposited onto each of the anti-reflection layers. The hydrophobic coating may be deposited using an electron gun or thermal evaporation.

Optionally, depositing the anti-reflection coatings is done with an electron gun. Optionally, depositing the anti-reflection coatings is done by thermal evaporation.

The method for preparing blue-light-reflecting lenses requires an electron gun power of about 7% to 58%, a thermal evaporation power of about 5% to about 25%, an anode voltage of about 78 Volts (V) to 132 V, an anode current of about 0.5 Amperes (A) to 6 A, an O2 flow rate between about 0 cm3/min and about 55 cm3/min (in other words, 0 standard cubic centimeters per minute (sccm) and about 36 sccm), and an Ar flow rate of between about 0 cm3/min and about 50 cm3/min. Additionally, the vacuum coating chamber has a temperature between about 40° C. and about 65° C. and a pressure between about 3.0×10-2 Pascals (Pa) and about 3.0×10-6 Pa. Moreover, the evaporation rates for vacuum coating the anti-reflection layer are between about 0.3 nm/s and about 3.0 nm/s for SiO2, about 0.1 nm/s and about 2.7 nm/s for ZrO2, about 0.05 nm/s and about 0.4 nm/s for ITO, and about 0.05 nm/s and about 0.9 nm/s for Al2O3. Additionally, the evaporation rate for vacuum coating the hydrophobic coating is between about 0.05 nm/s and about 0.9 nm/s.

In a first example, a blue-light-blocking resin lens with a 1.67 refractive index is selected and processed into a −5.00 diopter (D) single vision prescription lens. As described above, the resin lens is cleaned and dried. Next, a hard coating is formulated to have 0.015% of 585 nm absorber and is applied to the resin lens via dip coating at a lifting speed of 1.8 mm/s. The resin lens with the hard coating is placed into a vacuum coating chamber with a temperature of 50° C. and a pressure of 3.0×10-3 Pa. As described above, Ar is used to bombard the hard coating with ion beams to activate the hard coating. Next, an electron gun is used to evaporate and deposit SiO2, ZrO2, SiO2, ZrO2, SiO2, ZrO2, ITO, Al2O3, and SiO2 in sequence to form the anti-reflection coating.

The first layer of SiO2 has a thickness of 95 nm, the first layer of ZrO2 has a thickness of 35 nm, the second layer of SiO2 has a thickness of 65 nm, the second layer of ZrO2 has a thickness of 110 nm, the third layer of SiO2 has a thickness of 36 nm, the third layer of ZrO2 has a thickness of 58 nm, the first layer of ITO has a thickness of 6 nm, the first layer of Al2O3 has a thickness of 10 nm, and the fourth layer of SiO2 has a thickness of 110 nm. The electron gun has a power of 40%, the resistance heat radiation has a power of 20%, the anode voltage is 100 V, the anode current is 3 A, the O2 flow rate is 29 sccm, and the Ar flow rate is 42 sccm. The evaporation rate of the anti-reflection coating is 1.5 nm/s for SiO2, 0.5 nm/s for ZrO2, 0.1 nm/s for ITO, 0.3 nm/s for Al2O3.

Finally, resistance thermal radiation is used to heat the anti-reflection coating and evaporate the hydrophobic coating onto the lens. The hydrophobic coating is applied with an evaporation rate of 0.3 nm/s and has a thickness of 15 nm.

In a second example, a blue-light-blocking resin substrate with a 1.61 refractive index is selected. After cleaning the substrate, 0.005% of 585 nm absorber is added into the substrate. The substrate is then cured, molded into a resin lens, clamped, and ultrasonically cleaned and dried. A hard coating solution containing 0.05% 585 nm absorber is dip coated onto the resin lens at a lifting speed of 1.8 mm/s. Next, the resin lens with the hard coating is placed into a vacuum coating chamber with a temperature of 50° C. and a pressure of 3.0×10-4 Pa. As described above, Ar is used to bombard the hard coating with ion beams to activate the hard coating. Next, an electron gun is used to evaporate and deposit SiO2, ZrO2, SiO2, ZrO2, SiO2, ZrO2, ITO, Al2O3, and SiO2 in sequence to form the anti-reflection coating.

The first layer of SiO2 has a thickness of 95 nm, the first layer of ZrO2 has a thickness of 45 nm, the second layer of SiO2 has a thickness of 55 nm, the second layer of ZrO2 has a thickness of 120 nm, the third layer of SiO2 has a thickness of 45 nm, the third layer of ZrO2 has a thickness of 60 nm, the first layer of ITO has a thickness of 6 nm, the first layer of Al2O3 has a thickness of 6 nm, and the fourth layer of SiO2 has a thickness of 90 nm. The electron gun has a power of 20%, the resistance heat radiation has a power of 10%, the anode voltage is 110 V, the anode current is 4 A, the O2 flow rate is 30 sccm, and the Ar flow rate is 36 sccm. The evaporation rate of the anti-reflection coating is 1.5 nm/s for SiO2, 0.5 nm/s for ZrO2, 0.1 nm/s for ITO, and 0.3 nm/s for Al2O3.

Finally, resistance thermal radiation is used to heat the anti-reflection coating and evaporate the hydrophobic coating onto the lens. The hydrophobic coating is applied with an evaporation rate of 0.2 nm/s and has a thickness of 20 nm.

In a third example, a blue-light-blocking resin lens with a 1.61 refractive index is selected and processed into a −2.00 D single vision prescription lens. As described above, the resin lens is cleaned and dried using ultrasound. Next, a hard coating is applied to the resin lens via dip coating at a lifting speed of 1.8 mm/s. The resin lens with the hard coating is placed into a vacuum coating chamber with a temperature of 50° C. and a pressure of 1.0×10-3 Pa. As described above, Ar is used to bombard the hard coating with ion beams to activate the hard coating. Next, an electron gun is used to evaporate and deposit SiO2, ZrO2, SiO2, ZrO2, ITO, Al2O3, and SiO2 in sequence to form the anti-reflection coating.

The first layer of SiO2 has a thickness of 88 nm, the first layer of ZrO2 has a thickness of 35 nm, the second layer of SiO2 has a thickness of 60 nm, the second layer of ZrO2 has a thickness of 100 nm, the first layer of ITO has a thickness of 7 nm, the first layer of Al2O3 has a thickness of 10 nm, and the fourth layer of SiO2 has a thickness of 100 nm. In this example, the third layers of SiO2 and ZrO2 are omitted from the anti-reflection coating. The electron gun has a power of 40%, the resistance heat radiation has a power of 15%, the anode voltage is 110 V, the anode current is 3 A, the O2 flow rate is 35 sccm, and the Ar flow rate is 45 sccm. The evaporation rate of the anti-reflection coating is 3 nm/s for SiO2, 0.9 nm/s for ZrO2, 0.2 nm/s for ITO, and 0.9 nm/s for Al2O3.

Finally, resistance thermal radiation is used to heat the anti-reflection coating and evaporate the hydrophobic coating onto the lens. The hydrophobic coating is applied with an evaporation rate of 0.3 nm/s and has a thickness of 20 nm.

In a fourth example, the method for manufacturing the blue-light-blocking lens is the same as in the third example except that the evaporation rate for the application of Al2O3 is 0.5 nm/s.

The performance test results of each of these four examples as compared to the functional criterion is provided in Table 1.

TABLE 1
Performance Test Results of Examples 1-4

| | Criter- | Exam- | Exam- | Exam- | Exam- |
|---|---|---|---|---|---|
| | ion | ple 1 | ple 2 | ple 3 | ple 4 |
| Contact Angle | ≥110° | 116° | 118° | 107° | 106° |
| Boil Adhesion | ≥95% | OK | OK | OK | OK |
| Drop Ball Test | Complies | OK | OK | OK | OK |
| | with FDA | | | | |
| Surface | ≥5 H | 7 H | 7 H | 7 H | 7 H |
| Hardness | | | | | |
| 380-780 nm | ≥75% | 92.46% | 92.11% | 95.81% | 93.47% |
| Transmittance | | | | | |
| Rate, % | | | | | |
| 400-455 nm | ≥50% | 52.42% | 53.10% | 32.49% | 51.97% |
| Blocking | | | | | |
| Rate, % | | | | | |
| 400-500 nm | ≥80% | 90.08% | 90.75% | 97.10% | 77.07% |
| Blocking | | | | | |
| Rate, % | | | | | |
| 585 nm | 80% ± | 84.67% | 83.08% | 96.56% | 98.07% |
| Transmittance | 10% | | | | |
| Rate, % | | | | | |
| Base Color | / | Yellowish | Yellowish | Yellowish | Yellow |
| Color | Uni- | OK | OK | OK | No |
| Uniformity | formity | | | | good |

The performance test results show that the slightly yellow, blue light blocking spectacle lenses produced in accordance with the methods disclosed herein can effectively block the high-energy blue light with wavelengths between 400 nm and 455 nm that causes glare and, at the same time, ensure the high transmittance of visible light in the 455 nm to 500 nm wavelengths, as well as other visible light. Additionally, the lenses produced in accordance with the methods disclosed herein reduce the fatigue-inducing light of the 585 nm band. Furthermore, the surface hardness and smoothness of the lenses are much higher than other yellow, blue light blocking lenses in the market. Finally, the blue-light-blocking lenses disclosed herein have only a slightly yellow, uniform tint that does not interfere with vision, making the lenses very suitable for daily and work wear.

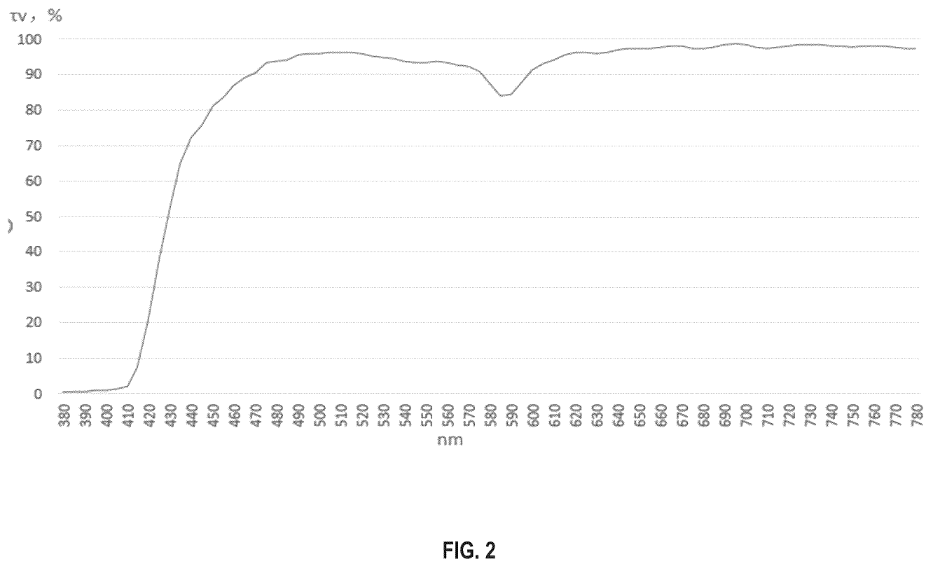

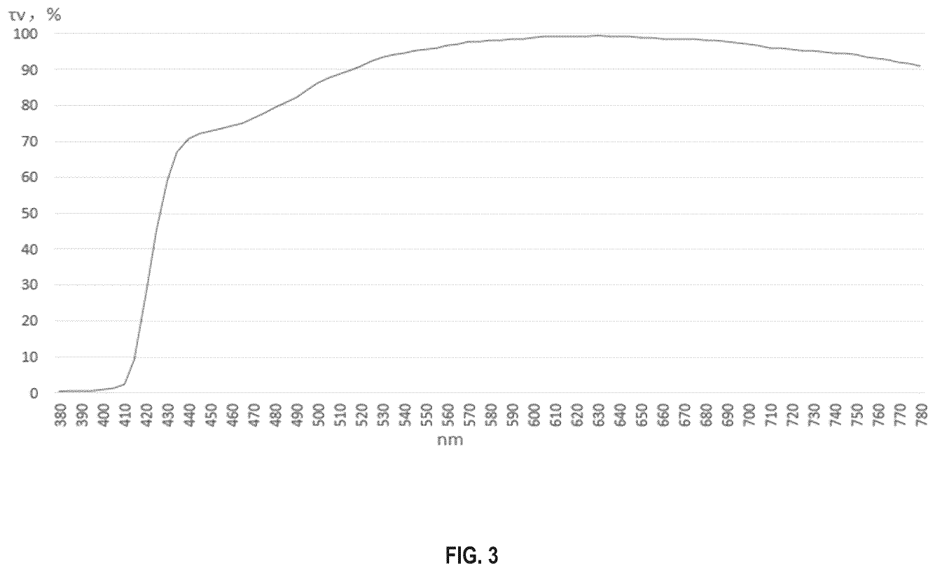

Referring now to FIGS. 2 and 3, the visible light spectrum can be transmitted through the blue-light-reflecting lens in use, and FIGS. 2 and 3 illustrate the exceptional performance of the presently disclosed blue-light-reflecting lens, according to some embodiments. Although the values are representative of the noteworthy anti-near-infrared radiation coating having the properties disclosed above in the first and fourth examples, these values are also representative of various other coatings that might be arranged or configured slightly differently than the noteworthy anti-near-infrared radiation coating.

FIG. 2 illustrates the spectrum of radiation that is transmitted by the first example of the blue-light-reflecting eyeglass lens, according to some embodiments of the present disclosure. The curve in FIG. 2 can be analyzed to calculate the percentage of blue light that is reflected by the eyeglass lens. Such calculations obtain the area under the curve (transmitted visible light, including blue light) compared to the area above the curve (reflected visible light, including blue light). These calculations demonstrate that the blue-light-reflecting eyeglass lenses of the first example reflect an average of 52% of blue light in the wavelength range of about 400 nm to 455 nm, which is the portion of the blue light spectrum with the highest intensity (i.e., the portion of the blue light spectrum that is most likely to cause vision fatigue and ocular complications). At the same time, the blue-light-reflecting eyeglass lenses of the first example allow transmittance of about 92% of the visible light spectrum (380 nm to 780 nm).

FIG. 3 illustrates the spectrum of radiation that is transmitted by the fourth example of the blue-light-reflecting eyeglass lens, according to some embodiments of the present disclosure. The calculations conducted on the curve in FIG. 2 can also be applied to the curve in FIG. 3. The calculations demonstrate that the blue-light-reflecting eyeglass lenses of the fourth example reflect an average of 52% of light in the wavelength range of about 400 nm to 455 nm. At the same time, the blue-light-reflecting eyeglass lenses of the fourth example allow transmittance of 93% of the visible light spectrum (380 nm to 780 nm).

### Anti-Fog Lenses

The present disclosure also provides for eyewear (such as glasses, goggles, or other eyewear) that can comprise an anti-fog coating that is effective to reduce fogging on the eyewear and provide superior clarity and visibility through the eyewear. Optionally, such embodiments can also include an anti-reflection layer or coating that is effective to mitigate the harmful effects of blue light. In embodiments of the anti-fog lenses that also include the anti-reflection layer, the lenses can have a light-yellow tint that is minimally intrusive to the wearer's vision (as compared to traditional blue-light blocking lenses that have a dark yellow tint, as described above). Optionally, such embodiments can include a tinting layer that enhances the color contrast perceived by the wearer.

Some embodiments of the present disclosure provide for anti-fog eyeglass lenses configured to resist the formation of condensation and, thus, fog on the eyeglass lens. Existing eyeglasses and anti-fog solutions are not designed to prevent fogging for extended periods of use.

In accordance with at least some embodiments disclosed herein is the realization that condensation that gathers on eyeglasses is inconvenient because it forms a fog that obscures the wearer's vision. Moreover, to remove the layer of fog formed on the eyeglasses, the wearer must wipe the glasses, which often results in streak marks that can also obscure the wearer's vision.

The eyeglass lenses described herein are designed to be resistant to condensation, which means that a layer of fog will not form on the eyeglass lenses. The eyeglass lenses include a layered structure that is designed to reduce the surface tension of beads of condensation. With reduced surface tension, the beads of condensation can aggregate to form an ultra-thin water film on the eyeglass lenses instead of a layer of fog. The uniform, ultra-thin water film can be preferable to the layer of fog because, while the numerous individual droplets that make up the layer of fog scatter light rays in a manner that significantly obscures vision, the ultra-thin water film can create a continuous layer that allows light to pass through with minimal distortion, allowing clearer vision through the lens.

The eyeglass lens is a vacuum coated resin lens with a layered structure. The layered structure includes a hardened layer disposed on one or both sides of the resin lens, an anti-reflection coating that is vacuum coated onto one or both sides of the hardened layer, and an anti-fog layer that is vacuum coated onto one or both sides of the anti-reflection coating.

The anti-fog eyeglass lens disclosed herein can be washed repeatedly and maintain its anti-fog effects. This design also evades the need for anti-fog spray, which reduces cost and environmental pollution. Moreover, this design allows for a surface hardness of up to about 7 H, which indicates a very hard surface that is resistant to scratching. Thus, such a high surface hardness minimizes the impact of scratches on the surface of the lens, which can increase the longevity of the lens and maintain clear vision through the lenses. Finally, compared to conventional anti-fog lenses, which only transmit up to 89% of visible light, the anti-fog lenses according to the present disclosure can transmit up to 97% of visible light.

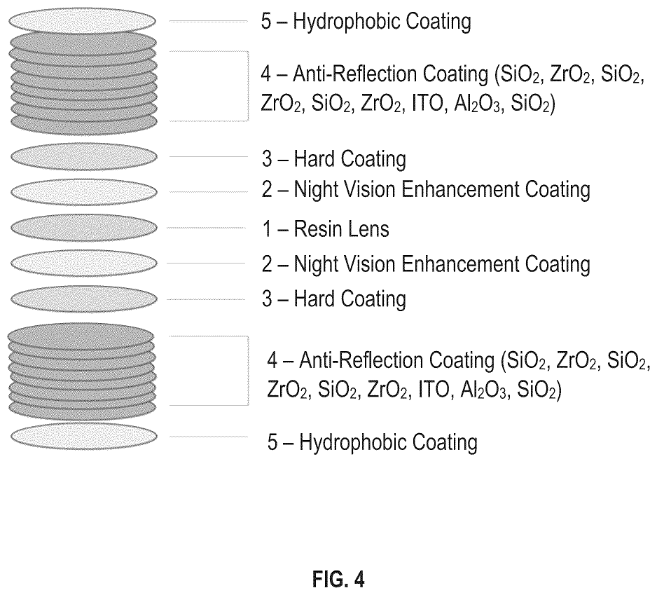

FIG. 4 illustrates an exploded view of the layers that constitute the layered structure of an anti-fog eyeglass lens, according to some embodiments of the present disclosure. The layered structure includes a resin lens 1, night vision enhancement coatings 2, hard coatings 3, anti-reflection coatings 4, and hydrophobic, anti-fog coatings 5. Each of these layers is described in greater detail below.

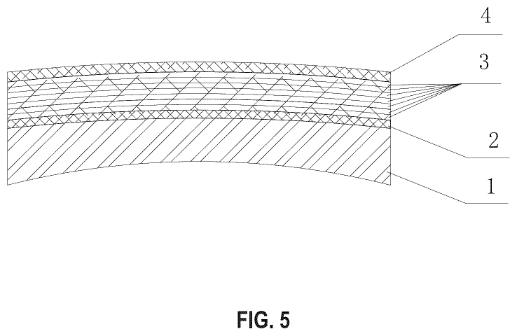

FIG. 5 illustrates a cross-sectional view of the layered structure of an anti-fog eyeglass lens, according to some embodiments of the present disclosure. The layered structure includes a resin lens 1, a hardened coating 2, an anti-reflection coating 3, and an anti-fog coating 4. In the embodiment shown, the hardened coating 2, the anti-reflection coating 3, and the anti-fog coating 4 are only applied to one side of the resin lens 1. In other embodiments, the hardened coating 2, the anti-reflection coating 3, and the anti-fog coating 4 are applied to both sides of the resin lens 1.

The resin lens can be a flat structure with two opposite sides (i.e., a front side and a back side). The two opposite sides are referred to as the first surface and the second surface. Optionally, the resin lens is a polyurethane resin lens.

Optionally, the resin lens can have a refractive index between about 1.49 and about 1.74. In some embodiments, the refractive index is about 1.61. In other embodiments, the refractive index is about 1.67.

In some embodiments, a night vision enhancement coating can be applied to the resin lens. Placing the night vision enhancement coating directly on the resin lens can facilitate improved light transmission and contrast—especially in low-light conditions. This ensures that the night vision enhancement features are closer to the lens material, which improves the performance of the night vision coating without being compromised by the other layers.

In some embodiments, the resin lens is a hardened resin lens. The first surface is activated by ion bombardment. Ion bombardment applies a denser film layer on the first surface of the resin lens, which creates the hardened layer. Optionally, the second surface is also activated by ion bombardment to create a second hardened layer.

Optionally, the hard coating can be a wear-resistant hardened film. The hardened film is wear-resistant in that it is more durable, which means that the eyeglass lens will resist condensation for a longer period of use. Optionally, the wear-resistant hardened coating can be dip coated on the first and/or second surfaces of the resin lens.

Optionally, the hard coating can be evenly distributed on the first and/or second surfaces of the resin lens.

Optionally, the hard coating can increase the surface density of the anti-fog lens. In some embodiments, the hard coating can increase the scratch-resistance of the anti-fog lens.

An anti-reflection coating is disposed on each hard coating. This positioning can reduce the wearer's perception of glare and reflections through the lenses without interference from scratches or other damage that the hard coating can protect against. The anti-reflection coating is formed by vacuum coating the resin lens and the hardened layer. Optionally, the anti-reflection coating is an anti-reflection film.

The anti-reflection coating has a layered structure that includes a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer. The layered structure is arranged with the first SiO₂ layer being nearest the resin lens in the fourth SiO₂ layer being farthest away from the resin lens.

Each layer can be arranged and applied at a specific thickness such that the layered structure interferes destructively with light rays in the blue portion of the visible light spectrum. For example, alternating layers of SiO₂ and ZrO₂, which have low and high refractive indices, respectively, can minimize the reflections perceived by the wearer and reduce the brightness of glare-both of which are critical for blocking blue light without compromising the clarity of vision. This can be made possible by alternating the layers of SiO₂ and ZrO₂ to create the correct interference effects to minimize reflections. This layering helps to maximize transparency and minimize glare.

In some embodiments, the layers of the anti-reflection coating are arranged to gradually transition the refractive indices. For example, starting with the first SiO₂ layer nearest the resin lens ensures a smooth transition from the lens material to the anti-reflection coating. The progression through the alternating layers of ZrO₂ and SiO₂ helps to manage how light transitions through the different materials, reducing internal reflections and optimizing light transmission.

In embodiments where the anti-fog lens is also configured to reflect blue light, the placement of the ITO layer after the third ZrO₂ layer can optimize blue-light blocking. Because the ITO layer has conductive and blue-light blocking properties, positioning the ITO layer deeper in the structure allows the ITO layer to interact effectively with the light modified by the previous layers, while still being protected by the outer layers.

Optionally, the Al₂O₃ layer can add durability to the lens and enhance the hardness of the anti-reflection layer. Placing the Al₂O₃ layer before the fourth SiO₂ layer can provide structural integrity to the anti-reflection coating while protecting the ITO layer.

Optionally, the fourth SiO₂ layer can be positioned as the outermost part of the anti-reflection coating. This placement helps to create a smooth transition from the anti-reflection coating to the environment. The placement of the fourth SiO₂ layer can maintain a clear and durable lens surface that is compatible with any additional coatings, such as hydrophobic layers.

The thickness of the layers in the layered structure varies throughout the structure. The first SiO2 layer is between about 50 nm and about 130 nm thick. The first ZrO2 layer is between about 2 nm and about 70 nm thick. The second SiO₂ layer is between about 8 nm and about 115 nm thick. The second ZrO2 layer is between about 2 nm and about 1100 nm thick. The third SiO₂ layer is between about 2 nm and about 70 nm thick. The third ZrO₂ layer is between about 8 nm and about 115 nm thick. The first ITO layer is between about 4 nm and about 11 nm thick. The first Al₂O₃ layer is between about 4 nm and about 11 nm thick. Finally, the fourth SiO₂ layer is between about 50 nm and about 130 nm thick.

In other embodiments, the first SiO₂ layer is between about 60 nm and about 120 nm thick. The first ZrO₂ layer is between about 5 nm and about 60 nm thick. The second SiO2 layer is between about 20 nm and about 100 nm thick. The second ZrO₂ layer is between about 20 nm and about 1000 nm thick. The third SiO₂ layer is between about 5 nm and about 60 nm thick. The third ZrO₂ layer is between about 20 nm and about 100 nm thick. The first ITO layer is between about 5 nm and about 10 nm thick. The first Al₂O₃ layer is between about 5 nm and about 10 nm thick. Finally, the fourth SiO2 layer is between about 60 nm and about 120 nm thick.

In some embodiments, the first SiO₂ layer is between about 60 nm and about 100 nm thick. The first ZrO₂ layer is between about 8 nm and about 20 nm thick. The second SiO₂ layer is between about 50 nm and about 110 nm thick. The second ZrO₂ layer is between about 20 nm and about 70 nm thick. The third SiO₂ layer is between about 50 nm and about 110 nm thick. The third ZrO₂ layer is between about 40 nm and about 100 nm thick. The first ITO layer is between about 5 nm and about 20 nm thick. The first Al₂O₃ layer is between about 5 nm and about 20 nm thick. Finally, the fourth SiO₂ layer is between about 60 nm and about 120 nm thick.

In some embodiments, the first SiO₂ layer is between about 110 nm and about 125 nm thick. The first ZrO₂ layer is between about 20 nm and about 30 nm thick. The second SiO₂ layer is between about 15 nm and about 25 nm thick. The second ZrO₂ layer is between about 40 nm and about 50 nm thick. The first ITO layer is between about 6 nm and about 10 nm thick. The first Al₂O₃ layer is between about 5 nm and about 10 nm thick. Finally, the fourth SiO₂ layer is between about 45 nm and about 70 nm thick.

Optionally, the first SiO₂ layer is about 115 nm thick, the first ZrO₂ layer is about 25 nm thick, the second SiO₂ layer is about 20 nm thick, the second ZrO₂ layer is about 45 nm thick, the first ITO layer is about 8 nm thick, the first Al₂O₃ layer is about 6 nm thick, and the third SiO₂ layer is about 60 nm thick.

Optionally, the first SiO₂ layer is about 118 nm thick, the first ZrO₂ layer is about 25 nm thick, the second SiO₂ layer is about 20 nm thick, the second ZrO₂ layer is about 46 nm thick, the first ITO layer is about 10 nm thick, the first Al₂O₃ layer is about 6 nm thick, and the third SiO₂ layer is about 55 nm thick.

Optionally, the first SiO₂ layer is about 120 nm thick, the first ZrO₂ layer is about 30 nm thick, the second SiO₂ layer is about 20 nm thick, the second ZrO₂ layer is about 50 nm thick, the first ITO layer is about 6 nm thick, the first Al₂O₃ layer is about 10 nm thick, and the third SiO₂ layer is about 65 nm thick. Optionally, the anti-reflection coating can also include a layer of Ti₃O₅ that is about 30 nm thick. In some embodiments, the layer of Ti₃O₅ can be disposed on the anti-reflection coating.

Optionally, the first SiO₂ layer is about 120 nm thick, the first ZrO₂ layer is about 30 nm thick, the second SiO₂ layer is about 20 nm thick, the second ZrO₂ layer is about 50 nm thick, the first ITO layer is about 6 nm thick, the first Al₂O₃ layer is about 10 nm thick, and the third SiO2 layer is about 65 nm thick. Optionally, the anti-reflection coating also includes a layer of HT-100 that is about 15 nm thick. In the alternative, the layer of HT-100 can be disposed on the anti-reflection coating.

A hydrophobic, anti-fog coating can be activated by ion bombardment and disposed on each anti-reflection coating by vacuum coating. The anti-fog coating can resist the formation of condensation through a combination of chemical properties and physical structure. The anti-fog coating can be the outermost layer of the anti-fog lenses to ensure that the anti-fog coating directly interacts with moisture and condensation. Moreover, the hydrophobic property of the anti-fog coating can repel water droplets, making the lens easier to clean while also maintaining clarity of vision through the lens.

For example, the anti-fog coating can be activated by ion bombardment, which can modify the surface properties of the lens to be more hydrophilic. A hydrophilic lens can encourage the spread of water molecules across the surface of the lens, which can encourage the formation of the ultra-thin water film and can discourage the formation of a layer of fog or condensation.

Optionally, the anti-fog coating comprises a silicone polymer, which has hydrophilic properties that encourage the water droplets to form a thin film rather than a layer of fog or condensation. The silicone polymer can be heated during vacuum coating, which can fine tune the hydrophilic properties of the silicone polymers for optimal anti-fogging performance. In other embodiments, the anti-fog coating comprises an organic silicon polymer film layer.

Furthermore, the anti-fog coating is formed by vacuum coating the resin lens, the hardened coating, and the anti-reflection coating. In particular, the anti-fog coating is formed by thermal evaporation. With this coating process, extremely thin, uniform layers of material can be deposited onto the lens such that each layer adheres well to the layers beneath it. The application of thin, uniform layers can reduce vision obstruction as compared to traditional lenses.

The anti-fog layer can have a thickness between about 5 nm and about 110 nm. Optionally, the anti-fog layer can have a thickness between about 10 nm and about 100 nm. Optionally, the anti-fog layer can have a thickness between about 10 nm and about 50 nm. In some embodiments, the anti-fog coating can have a thickness of about 25 nm, about 20 nm, or about 16 nm. In some embodiments, the effectiveness of the anti-fog layer can be dependent on the anti-fog layer having a thickness that maximizes surface area without compromising transparency.

The present disclosure also includes methods for manufacturing an anti-fog eyeglass lens. Such a method may include providing a resin lens as previously described with respect to FIGS. 4 and about 5. The method may further include cleaning the resin lens with ultrasonic waves and drying the resin lens. The method may include cooling the resin lens to room temperature. A hardened coating may be applied to one or both sides of the resin lens. The method may also include placing the resin lens in a vacuum coating chamber and vacuum coating an anti-reflection coating and an anti-fog coating onto the lens. Vacuum coating the anti-reflection coating onto each of the hard coatings may include bombarding each of the hard coatings with Ar ions to activate each of the hard coatings. Vacuum coating the anti-reflection coating onto each hard coating may also include depositing a layered structure of SiO₂, ZrO₂, ITO, and Al₂O₃ onto each hard coating, as described above. Vacuum coating the anti-fog coating onto each of the anti-reflection coatings may include bombarding each of the anti-reflection coatings with Ar ions to activate each of the anti-reflection coatings and depositing the anti-fog coating on each of the anti-reflection coatings.

Optionally, cleaning the resin lens with ultrasonic waves and drying the resin lens may include placing the resin lens in an oven or heating chamber. Optionally, the oven has a temperature between about 50° C. and about 70° C. Optionally, the resin lens is placed on the oven for a time between about 20 minutes and about 40 minutes. In some embodiments, the oven has a temperature of about 60° C., and the resin lens is dried in the oven for about 30 minutes.

Optionally, depositing the anti-reflection and anti-fog coatings is done with an electron gun. Optionally, depositing the anti-reflection and anti-fog coatings is done by thermal evaporation.

Optionally, the method provides for curing the resin lens, the hardened layer, the anti-reflection coating, and the anti-fog layer at room temperature for approximately two hours.

The method for preparing vacuum coated anti-fog lenses requires an electron gun power of about 10% to 50%, a thermal evaporation power of about 10% to 15%, an anode voltage of about 90 V to 120 V, an anode current of about 1 A to 3 A, an O₂ flow rate between about 0 sccm and about 31 sccm, and an Ar flow rate of between about 0 sccm and about 51 sccm. Additionally, the vacuum coating chamber has a temperature between about 40° C. and about 65° C. and a pressure between about 3.0×10−2 Pa and about 3.0×10⁻⁶ Pa. Moreover, the evaporation rates for vacuum coating the anti-reflection layer are between about 0.3 nm/s and about 3 nm/s for SiO₂, about 0.1 nm/s to 2 nm/s for ZrO₂, and about 0.5 nm/s for Al₂O₃. Additionally, the evaporation rate for vacuum coating the anti-fog layer is between about 0.12 nm/s.

In a first example, a polyurethane resin lens with a 1.67 refractive index (such as the 1.67Blockz blue-light blocking lens), a film that can reduce exposure to high-energy visible blue light and block yellow light in the wavelength of about 585 nm, and a hardened surface is selected. The polyurethane lens is then cleaned via ultrasound and dried in a 60° C. oven for about 30 minutes. The resin lens is removed from the oven and allowed to cool until it reaches room temperature and then a hard coating is applied to the resin lens. Next, the resin lens with the hard coating is placed in a vacuum coating chamber with a pressure of 1.0×10⁻⁵ Pa. Ar is used to bombard the hard coating with ion beams to activate the hard coating. Subsequently, an electron gun is used to evaporate and deposit SiO₂, ZrO₂, SiO₂, ZrO₂, ITO, Al₂O₃, and SiO₂ in sequence to form the anti-reflection coating. Notably, because the lenses described herein are manufactured using non-fluorine materials, the manufacture of these lenses has a low environmental impact.

The first layer of SiO₂ has a thickness of 115 nm, the first layer of ZrO₂ has a thickness of 25 nm, the second layer of SiO₂ has a thickness of 20 nm, the second layer of ZrO₂ has a thickness of 45 nm, the first layer of ITO has a thickness of 8 nm, the first layer of Al₂O₃ has a thickness of 6 nm, and the third layer of SiO₂ has a thickness of 60 nm. The electron gun has a power of 10%, a thermal evaporation power of 15%, an anode voltage of 100 V, an anode current of 2 A, an O₂ flow rate of 20 sccm, and an Ar flow rate of 30 sccm. The evaporation rate of the anti-reflection coating is 0.8 nm/s for SiO₂, 1 nm/s for ZrO₂, 0.2 nm/s for ITO, and 0.5 nm/s for Al₂O₃. When the anti-reflection coating is applied, the vacuum chamber bombards the anti-reflection coating with ions to activate the anti-reflection coating. The ions are applied to the lens at a rate of less than 1 nm/s.

Finally, resistance thermal radiation is used to evaporate the anti-fog coating onto the lens. The anti-fog coating is applied with an evaporation rate of 0.1 nm/s and has a thickness of 25 nm.

In a second example, a hardened resin lens with a 1.61 refractive index (such as the 1.61 Blockz blue-light blocking lens) and a film that can reduce exposure to high-energy visible blue light and block yellow light in the wavelength of about 585 nm is selected. The hardened resin lens is then cleaned via ultrasound and dried in a 60° C. oven for about 30 minutes. The resin lens is removed from the oven and allowed to cool until it reaches room temperature. Next, the hardened resin lens is placed in a vacuum coating chamber with a pressure of 1.0×10⁻³ Pa. Ar is used to bombard the hardened resin lens with ion beams to activate the surface of the hardened resin lens, and then an electron gun is used to evaporate and deposit SiO₂, ZrO₂, SiO₂, ZrO₂, ITO, Al₂O₃, and SiO₂ in sequence to form the anti-reflection coating.

The first layer of SiO₂ has a thickness of 118 nm, the first layer of ZrO₂ has a thickness of 25 nm, the second layer of SiO₂ has a thickness of 20 nm, the second layer of ZrO₂ has a thickness of 46 nm, the first layer of ITO has a thickness of 10 nm, the first layer of Al₂O₃ has a thickness of 6 nm, and the third layer of SiO₂ has a thickness of 55 nm. The electron gun has a power of 15%, a thermal evaporation power of 12%, an anode voltage of 120 V, an anode current of 3 A, an O₂ flow rate of 10 sccm, and an Ar flow rate of 30 sccm. The evaporation rate of the anti-reflection coating is 0.6 nm/s for SiO₂, 1.5 nm/s for ZrO₂, 0.2 nm/s for ITO, and 0.5 nm/s for Al₂O₃. When the anti-reflection coating is applied, the vacuum chamber bombards the anti-reflection coating with ions to activate the anti-reflection coating. The ions are applied to the lens at a rate of about 0.5 nm/s.

Finally, resistance thermal radiation is used to evaporate the anti-fog coating onto the lens. The anti-fog coating is applied with an evaporation rate of 0.2 nm/s and has a thickness of 16 nm.

In a third example, a hardened resin lens is cleaned via ultrasound and dried in a 60° C. oven for about 30 minutes. The resin lens is removed from the oven and allowed to cool until it reaches room temperature. Next, the hardened resin lens is placed in a vacuum coating chamber with a pressure of 1.0×10⁻³ Pa. Ar is used to bombard the hardened resin lens with ion beams to activate the surface of the hardened resin lens, and then an electron gun is used to evaporate and deposit SiO₂, ZrO₂, SiO₂, ZrO₂, ITO, Al₂O₃, and SiO₂ in sequence to form the anti-reflection coating.

The first layer of SiO₂ has a thickness of 120 nm, the first layer of ZrO₂ has a thickness of 30 nm, the second layer of SiO₂ has a thickness of 20 nm, the second layer of ZrO₂ has a thickness of 50 nm, the first layer of ITO has a thickness of 6 nm, the first layer of Al₂O₃ has a thickness of 10 nm, and the third layer of SiO₂ has a thickness of 65 nm. In this third example, the electron gun also deposits a layer of Ti₃O₅ with a thickness of 30 nm on the lens as part of the anti-reflection coating. The electron gun has a power of 10%, a thermal evaporation power of 13%, an anode voltage of 90 V, an anode current of 3 A, an O₂ flow rate of 30 sccm, and an Ar flow rate of 20 sccm. The evaporation rate of the anti-reflection coating is 1 nm/s for SiO₂, 1 nm/s for ZrO₂, 0.2 nm/s for ITO, and 0.5 nm/s for Al₂O₃. When the anti-reflection coating is applied, the vacuum chamber bombards the anti-reflection coating with ions to activate the anti-reflection coating. The ions are applied to the lens at a rate of about 1.5 nm/s.

Finally, resistance thermal radiation is used to evaporate the anti-fog coating onto the lens. The anti-fog coating is applied with an evaporation rate of 0.1 nm/s and has a thickness of 20 nm.

In each of the first three examples, the evaporation thickness is between about 10 nm and 100 nm.

In a fourth example, a hardened resin lens with a 1.61 refractive index and a green film is cleaned via ultrasound and dried in a 60° C. oven for about 30 minutes. The resin lens is removed from the oven and allowed to cool until it reaches room temperature. Next, the hardened resin lens is placed in a vacuum coating chamber with a pressure of 1.0×10⁻⁵ Pa. Ar is used to bombard the hardened resin lens with ion beams to activate the surface of the hardened resin lens, and then an electron gun is used to evaporate and deposit SiO₂, ZrO₂, SiO₂, ZrO₂, ITO, Al₂O₃, and SiO₂ in sequence to form the anti-reflection coating.

The first layer of SiO₂ has a thickness of 120 nm, the first layer of ZrO₂ has a thickness of 30 nm, the second layer of SiO₂ has a thickness of 20 nm, the second layer of ZrO₂ has a thickness of 50 nm, the first layer of ITO has a thickness of 6 nm, the first layer of Al₂O₃ has a thickness of 10 nm, and the third layer of SiO₂ has a thickness of 65 nm. In this fourth example, the electron gun also deposits a layer of HT-100 with a thickness of 15 nm on the lens as part of the anti-reflection coating. The electron gun has a power of 10%, an anode voltage of 90 V, an anode current of 3 A, an O₂ flow rate of 30 sccm, and an Ar flow rate of 20 sccm. The evaporation rate of the anti-reflection coating is 1 nm/s for SiO₂, 1 nm/s for ZrO₂, 0.2 nm/s for ITO, and 0.5 nm/s for Al₂O₃. When the anti-reflection coating is applied, the vacuum chamber bombards the anti-reflection coating with ions to activate the anti-reflection coating.

Finally, resistance thermal radiation is used to evaporate the anti-fog coating onto the lens. The anti-fog coating is applied with an evaporation rate of 0.1 nm/s.

In a fifth example, a hardened resin lens with a 1.61 refractive index and a green film is cleaned via ultrasound and dried in a 60° C. oven for about 30 minutes. The resin lens is removed from the oven and allowed to cool until it reaches room temperature. Next, the surface of the hardened resin lens is coated with polymer anti-fog solution and cured at room temperature for about 2 hours.

The performance test results of four of these five examples, as compared to a conventional anti-fog lens, is provided in Table 2.

TABLE 2
Performance Test Results of a Conventional Anti-Fog Lens as
Compared to the Anti-Fog Lens of Examples 1, 2, 4, and 5

| | Standard | Example 1 | Example 2 | Example 4 | Example 5 |
|---|---|---|---|---|---|
| Water Contact | ≤15° | 4° | 3° | 110° | 8° |
| Angle | | | | | |
| Boil Adhesion | ≥95% | 100% | 100% | 100% | 90% |
| Transmittance | ≥90% | 96.51% | 96.73% | 95.67% | 89% |
| Anti-Fog | 60° C. | Conforms | Conforms | Does not | Conforms |
| Performance | saturated | | | conform | |
| | steam, 5 cm | | | | |
| | distance, | | | | |
| | fumigation for | | | | |
| | 3 minutes | | | | |
| | without | | | | |
| | fogging | | | | |
| Anti-Fog | Soak in water | Conforms | Conforms | Does not | Conforms |
| Performance | for 1 hour, | | | conform | |
| | anti-fog | | | | |
| | time > 8 s | | | | |
| Falling Sand | Complies | Conforms | Conforms | Does not | Conforms |
| Wear | with EN-166 | | | conform | |
| Resistance | standard | | | | |
| Surface | >2 H | 7 H | 7 H | 7 H | 1 H |
| Hardness | | | | | |
| Daytime or | Uninterrupted | No good | Qualified | No good | No good |
| Bright | view | | | | |
| Weather | | | | | |
| Night or | Uninterrupted | Qualified | Qualified | No good | No good |
| Cloudy | view | | | | |
| Weather | | | | | |

### Blue-Light-Blocking, Anti-Fog Lenses

In accordance with at least some embodiments disclosed herein is the realization that a person's exposure to blue light and the formation of fog on the person's eyeglasses can be limited by eyeglass lenses configured to block blue light and prevent the formation of fog. However, existing eyeglasses that block blue light often impair the wearer's vision, and conventional methods for preventing the formation of fog on lenses require regular maintenance from the wearer.

Some embodiments of the present disclosure provide eyewear (such as glasses, goggles, or other eyewear) that can comprise an anti-reflection layer or coating that is effective to mitigate the harmful effects of blue light and an anti-fog coating that resists the formation of condensation and, thus, fog on the eyeglass lens. Optionally, such embodiments can include a tinting layer that enhances the color contrast perceived by the wearer.

The lens described in this section of the present disclosure incorporate the features and benefits described above in previous sections of the present disclosure (which pertain to the blue-light-blocking lens and the anti-fog lens) to the extent that those features and benefits do not conflict with the features and benefits set forth in this section.

The lenses described herein provide for a blue-light-reflecting eyeglass lens configured to limit blue light exposure and the harmful effects of blue light exposure while also transmitting visible light. Specifically, the lenses described herein are configured to reflect light with a wavelength between about 440 nm and about 460 nm (i.e., harmful blue light) while transmitting at least 91% of visible light. Optionally, the lenses can reflect harmful blue light with a wavelength of about 450 nm. Optionally, the lenses can transmit at least 92% of visible light.

Furthermore, the eyeglass lenses described herein are designed to reflect blue light with only a slightly yellow tint evenly distributed across the lens and to prevent the formation of fog. The lenses can have a surface hardness of at least ~6 H, which effectively limits the impact of surface scratches on the blue-light-reflecting lens. In some embodiments, the lenses can have a surface hardness of at least ~7 H. Moreover, the lenses can discourage fog and fingerprints from forming on the lens and obstructing the wearer's field of vision by adopting either hydrophilic properties (where the lens has a water drop angle of less than) 5° or hydrophobic properties (where the lens has a water drop angle of at least) 100°. Lenses on both ends of the hydrophobicity spectrum can discourage fog and fingerprints by inducing water on the lens to spread out (hydrophilic) or bead up and roll off (hydrophobic). The coatings in these lenses are made with non-fluorine materials, which means that the manufacture of the lenses is environmentally friendly. Additionally, the lens has a haze value of less than 2%, which means that the lens has greater optical clarity as compared to conventional lenses, which typically have haze values between about 3% and 8%.

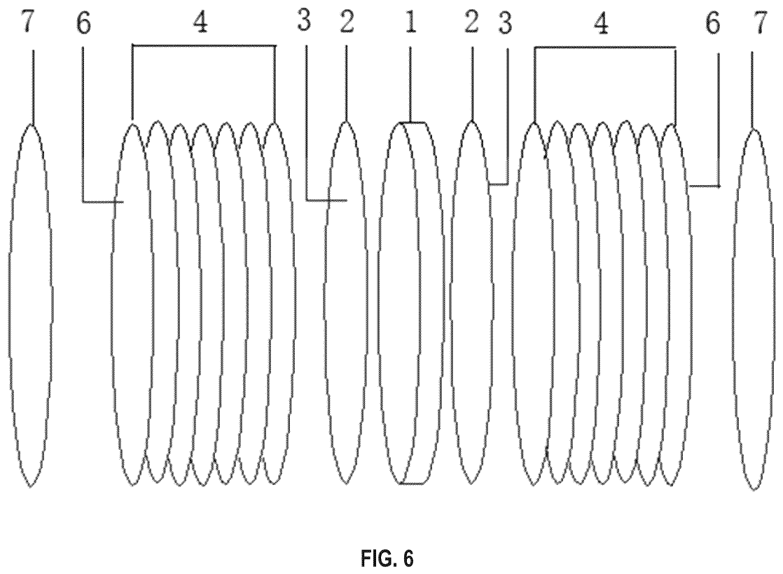

FIG. 6 illustrates an exploded view of the layers that constitute the layered structure of a first embodiment of an eyeglass lens that limits blue light exposure and the formation of fog, according to some embodiments of the present disclosure. In particular, FIG. 6 shows a coating structure that is symmetrical about a resin lens 1. While conventional blue-light-reflecting lenses often distort the wearer's vision, the symmetrical coating around the resin lens can reduces the distortive effect of blue-light reflecting lenses disclosed herein. Moreover, the symmetrical coating structure ensures consistent optical performance of the lenses in both directions. Both sides of the resin lens 1 are coated with a hard coating 2 (or hardened layer). Similarly, each hard coating 2 is coated with a hard coating activation layer 3. Next, each hard coating activation layer 3 is coated with an anti-reflection coating 4, which is a nine-layer structure that includes a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer. The first SiO₂ layer is adjacent to the hard coating activation layer 3, and the fourth SiO₂ layer is coated with an anti-reflection coating activation layer 6. The final coating in this structure is an anti-fog coating 7. Each of these coatings is described in greater detail below.

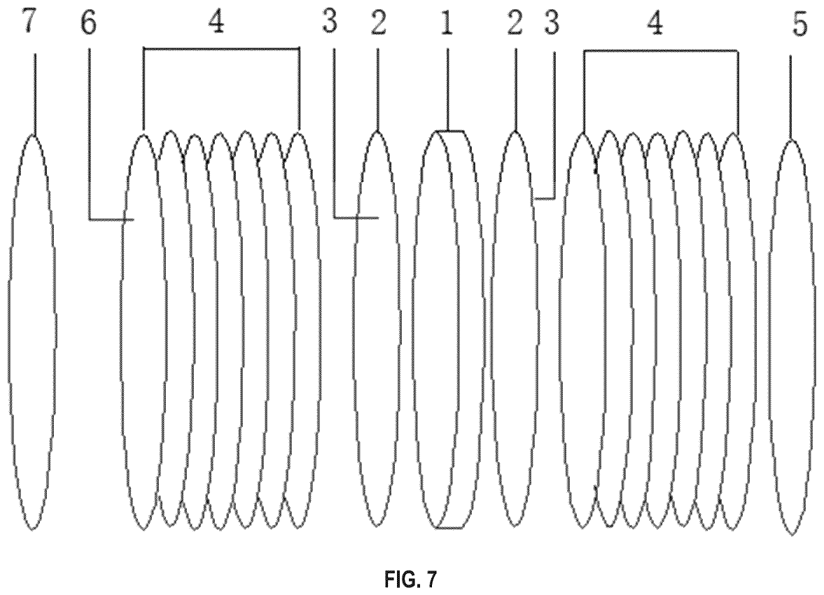

FIG. 7 illustrates an exploded view of the layers that constitute the layered structure of a second embodiment of an eyeglass lens that limits blue light exposure and the formation of fog, according to some embodiments of the present disclosure. This embodiment of the lens structure is asymmetrical and incorporates both a hydrophobic coating 5 and an anti-fog coating 7. Both sides of the resin lens 1 are coated with a hard coating 2 (or hardened layer). Similarly, each hard coating 2 is coated with a hard coating activation layer 3. Next, each hard coating activation layer 3 is coated with an anti-reflection coating 4, which is a nine-layer structure that includes a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer. The first SiO₂ layer is adjacent to the hard coating activation layer 3. One of the fourth SiO₂ layers is coated with a hydrophobic coating 5, and the other SiO₂ layer is coated with an anti-reflection coating activation layer 6 and an anti-fog coating 7. The anti-reflection coating activation layer 6 helps the anti-fog coating 7 adhere to the lens structure. In the embodiment shown in FIG. 6, the hydrophobic coating 5 faces away from the wearer's eyes, and the anti-fog coating 7 is closer to the wearer's eyes. Each of these coatings is described in greater detail below.

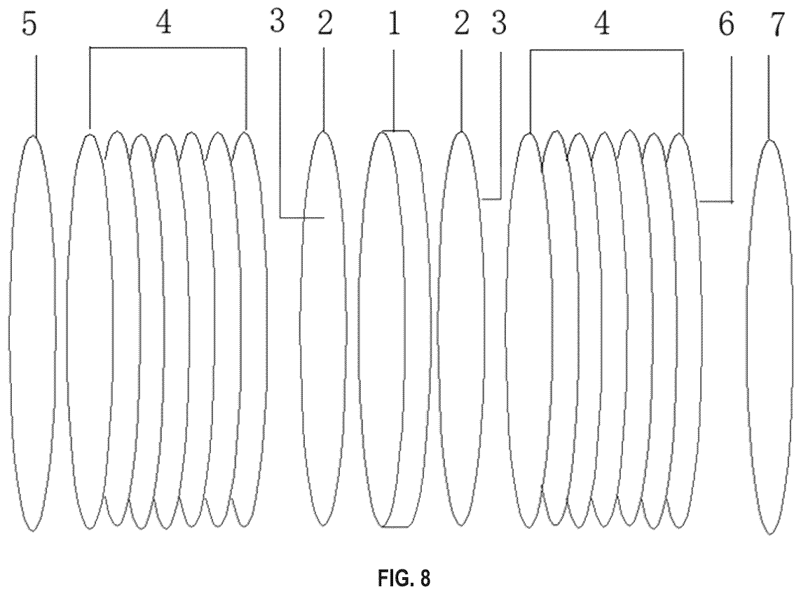

FIG. 8 illustrates an exploded view of the layers that constitute the layered structure of a third embodiment of an eyeglass lens that limits blue light exposure and the formation of fog, according to some embodiments of the present disclosure. This embodiment of the lens structure is also asymmetrical and incorporates both a hydrophobic coating 5 and an anti-fog coating 7. This third embodiment differs from the second embodiment in that the hydrophobic coating 5 and the anti-fog coating 7 have switched positions. That is, the anti-fog coating 7 faces away from the wearer's eyes, and the hydrophobic coating 5 is closer to the wearer's eyes. Each of these coatings is described in greater detail below.

The resin lens is a flat structure with two opposite sides (i.e., a front side and a back side). The two opposite sides can be referred to as the first surface and the second surface. The resin lens can have a refractive index between about 1.35 and about 1.87. In some embodiments, the resin lens can have a refractive index between about 1.41 and about 1.81. Optionally, the resin lens can have a refractive index of between about 1.4 to about 1.8, such as about 1.49, about 1.56, about 1.59, about 1.61, about 1.67, or about 1.74.

In some embodiments, the resin lens can be a blue light blocking resin lens. The blue light blocking resin lens can have a slightly yellow tint (as compared to the dark yellow tint of conventional blue light blocking lenses).

In some embodiments, the hard coating can be applied to the first and second surfaces of the resin lens. Optionally, the hard coating can be applied to only the first surface or the second surface of the resin lens. The thickness of the hard coating can be between about 0.5 μm and about 12 μm. Optionally, the thickness can be between about 1 μm and about 10 μm.

The hard coating can be applied directly to the resin lens, which makes the resin lens scratch-resistant and durable. This is essential for protecting the more sensitive anti-reflection coating, described in greater detail below. The hard coating can be applied directly to the resin lens via spin coating or dip coating. Optionally, the hard coating can be a silicone polymer or a wear-resistant material.

In some embodiments, the hard coating can be configured to absorb a narrow band of yellow light. This can be accomplished by adding narrow-band yellow light absorber to the hard coating. The narrow-band yellow light absorber can absorb between about 18% and about 17% of yellow light with a wavelength between about 577 nm and about 587 nm. Optionally, the narrow-band yellow light absorber can absorb between about 10% and about 15% of yellow light with a wavelength of about 582 nm.

Next, a hard coating activation layer is applied to each hard coating, and an anti-reflection coating is disposed on each hard coating activation layer. The hard coating activation layer facilitates robust adhesion of the anti-reflection coating to the lens structure. Further, by disposing the anti-reflection coating on top of the hard coating and its activation layer, the anti-reflection coating can reduce the wearer's perception of glare and reflections through the lenses without interference from scratches or other damage that the hard coating can protect against.

Additionally, the anti-reflection coating can be configured to reflect blue light with a wavelength up to about 440 nm and about 460 nm. Optionally, the anti-reflection coating is configured to reflect blue light with a wavelength up to about 450 nm.

The anti-reflection coating has a layered structure that includes a first SiO₂ layer, a first ZrO₂ layer, a second SiO₂ layer, a second ZrO₂ layer, a third SiO₂ layer, a third ZrO₂ layer, a first ITO layer, a first Al₂O₃ layer, and a fourth SiO₂ layer. The layered structure is arranged with the first SiO₂ layer being nearest the resin lens in the fourth SiO₂ layer being farthest away from the resin lens.

Each layer can be arranged and applied at a specific thickness such that the layered structure interferes destructively with light rays in the blue portion of the visible light spectrum. For example, alternating layers of SiO₂ (which has a low refractive index of approximately 1.45) and ZrO₂ (which has a high refractive index of approximately 2.21) can minimize the reflections perceived by the wearer and reduce the brightness of glare-both of which are critical for blocking blue light without compromising the clarity of vision. That is, alternating the layers of SiO₂ and ZrO₂ creates the correct interference effects to minimize reflections and glare while maximizing transparency.

In some embodiments, the layers of the anti-reflection coating are arranged to gradually transition the refractive indices. For example, starting with the first SiO₂ layer nearest the resin lens ensures a smooth transition from the lens material to the anti-reflection coating. The progression through the alternating layers of ZrO₂ and SiO₂ helps to manage how light transitions through the different materials, reducing internal reflections and optimizing light transmission.

Moreover, the placement of the ITO layer after the third ZrO₂ layer can optimize blue-light blocking. Because the ITO layer has conductive and blue-light blocking properties, positioning the ITO in a centrally internal layer allows the ITO layer to interact effectively with the light modified by the previous layers, while still being protected by the outer layers.

Optionally, the Al₂O₃ layer can add durability to the lens and enhance the hardness of the anti-reflection layer. Placing the Al₂O₃ layer before the fourth SiO₂ layer can provide structural integrity to the anti-reflection coating while protecting the ITO layer.

Optionally, the fourth SiO₂ layer can be positioned as the outermost part of the anti-reflection coating. This placement helps to create a smooth transition from the anti-reflection coating to the environment. The placement of the fourth SiO₂ layer can maintain a clear and durable lens surface that is compatible with any additional coatings, such as hydrophobic layers.

The thickness of the layers in the layered structure varies throughout the structure based on the functions being prioritized by different embodiments of the lenses. The thickness of each layer can be altered to balance different effects such as durability, light interference, and adhesion between different layers of the anti-reflection coating and the different coatings of the lens. The first SiO₂ layer is between about 80 nm and about 130 nm thick. The first ZrO₂ layer is between about 10 nm and about 25 nm thick. The second SiO₂ layer is between about 90 nm and about 120 nm thick. The second ZrO₂ layer is between about 15 nm and about 35 nm thick. The third SiO₂ layer is between about 90 nm and about 130 nm thick. The third ZrO₂ layer is between about 25 nm and about 55 nm thick. The first ITO layer is between about 10 nm and about 25 nm thick. The first Al₂O₃ layer is between about 1 nm and about 15 nm thick. Finally, the fourth SiO₂ layer is between about 135 nm and about 215 nm thick.

In other embodiments, the first SiO₂ layer is between about 90 nm and about 120 nm thick. The first ZrO₂ layer is between about 15 nm and about 20 nm thick. The second SiO₂ layer is between about 100 nm and about 110 nm thick. The second ZrO₂ layer is between about 20 nm and about 30 nm thick. The third SiO₂ layer is between about 100 nm and about 120 nm thick. The third ZrO₂ layer is between about 30 nm and about 50 nm thick. The first ITO layer is between about 15 nm and about 20 nm thick. The first Al₂O₃ layer is between about 5 nm and about 10 nm thick. Finally, the fourth SiO₂ layer is between about 150 nm and about 200 nm thick.

Optionally, the first SiO₂ layer is about 95 nm thick, the first ZrO₂ layer is about 15 nm thick, the second SiO₂ layer is about 90 nm thick, the second ZrO₂ layer is about 25 nm thick, the third SiO₂ layer is about 105 nm thick, the third ZrO₂ layer is about 45 nm thick, the first ITO layer is about 18 nm thick, the first Al₂O₃ layer is about 10 nm thick, and the fourth SiO₂ layer is about 155 nm thick.

Optionally, the first SiO₂ layer is about 98 nm thick, the first ZrO₂ layer is about 16 nm thick, the second SiO₂ layer is about 110 nm thick, the second ZrO₂ layer is about 25 nm thick, the third SiO₂ layer is about 100 nm thick, the third ZrO₂ layer is about 50 nm thick, the first ITO layer is about 15 nm thick, the first Al₂O₃ layer is about 7 nm thick, and the fourth SiO₂ layer is about 160 nm thick.

Optionally, the first SiO₂ layer is about 90 nm thick, the first ZrO₂ layer is about 15 nm thick, the second SiO₂ layer is about 106 nm thick, the second ZrO₂ layer is about 20 nm thick, the third SiO₂ layer is about 100 nm thick, the third ZrO₂ layer is about 50 nm thick, the first ITO layer is about 15 nm thick, the first Al₂O₃ layer is about 10 nm thick, and the fourth SiO₂ layer is about 180 nm thick.

Optionally, the first SiO₂ layer is about 120 nm thick, the first ZrO₂ layer is about 30 nm thick, the second SiO₂ layer is about 20 nm thick, the second ZrO₂ layer is about 50 nm thick, the first ITO layer is about 6 nm thick, the first Al₂O₃ layer is about 10 nm thick, and the third SiO₂ layer is about 65 nm thick. Optionally, the anti-reflection coating also includes a layer of HT-100 that is about 15 nm thick.

As mentioned above, an anti-reflection coating activation layer can be disposed on the outermost layer of the anti-reflection coating. In some embodiments, the anti-reflection coating activation layer is disposed on only one of the anti-reflection coatings. In other embodiments, the anti-reflection coating activation layer is disposed on both anti-reflection coatings.

Optionally, a hydrophobic coating can be applied to any exposed anti-reflection coatings (i.e., anti-reflection coating without an anti-reflection coating activation layer). The hydrophobic layer can have hydrophobic properties that can encourage water droplets on the lens (e.g., raindrops or condensation) to bead up and roll off the surface of the lens rather than spread out and form a thick layer of water that obscures vision. As a result, the hydrophobic layer can help maintain clear vision in wet conditions.

Similarly, the hydrophobic layer can repel oil and dirt, which helps wearers keep their lenses cleaner for longer and improves visibility. Because the hydrophobic layer can help keep the lenses clean, the hydrophobic layer can provide the added benefit of optimizing the function of all the layers beneath it. Further, the hydrophobic layer, as the outermost layer, can also serve to protect the layers beneath it from abrasion and wear. This can extend the life of the lenses by protecting the inner layers of the lenses against these stressors while maintaining the transparency of the lenses.

In some embodiments, the hydrophobic coating has a thickness between about 5 nm and about 55 nm. Optionally, the hydrophobic coating has a thickness between about 1 nm and about 150 nm or about 10 nm and about 50 nm. Some embodiments of the hydrophobic coating are made of a per- and polyfluoroalkyl substance (PFAS). In those embodiments, the hydrophobic coating can have a thickness between about 15 nm and about 35 nm. Optionally, a PFAS hydrophobic coating can be about 30 nm thick or about 20 nm thick.

Optionally, an anti-fog coating can be applied to one or both anti-reflection coating activation layers. The anti-fog coating can resist the formation of condensation through a combination of chemical properties and physical structure. The anti-fog coating can be the outermost layer of the anti-fog lenses to ensure that the anti-fog coating directly interacts with moisture and condensation. Moreover, the hydrophobic property of the anti-fog coating can repel water droplets, making the lens easier to clean while also maintaining clarity of vision through the lens.

In some embodiments, the anti-fog coating comprises a silicone polymer hydrophilic coating, which has hydrophilic properties that encourage the water droplets to form a thin film rather than a layer of fog or condensation. The silicone polymer hydrophilic anti-fog coating can have a thickness between about 25 nm and about 55 nm. Optionally, the thickness can be about 30 nm or about 50 nm.

In other embodiments, the anti-fog coating comprises a hydrophilic phosphoric acid organic material. This anti-fog coating also has hydrophilic properties that encourage the water droplets to form a thin film, which maintains clarity in the lens.

Optionally, the anti-fog coating comprises a surface hardness of at least about 6 H. In some embodiments, the surface hardness is about 7 H. This surface hardness is valuable because the anti-fog coating is an outer layer of the lens. Accordingly, the anti-fog coating can protect the inner layers of the lens because of its high surface hardness.

The anti-fog layer can have a thickness between about 15 nm and about 85 nm. Optionally, the thickness can be between about 20 nm and about 80 nm. In some embodiments, the effectiveness of the anti-fog layer can be dependent on the anti-fog layer having a thickness that maximizes surface area without compromising transparency.

The present disclosure also includes methods for manufacturing an anti-fog eyeglass lens. Such a method may include providing a resin lens as previously described with respect to FIGS. 6-8. The method may further include cleaning the resin lens with ultrasonic waves and drying the resin lens. The method may include cooling the resin lens to room temperature. A hardened coating may be applied to one or both sides of the resin lens, and each hard coating may be activated by bombarding each of the hard coatings with Ar ions to activate each of the hard coatings—thus forming a hard coating activation layer on each hard coating. The method may also include vacuum coating the anti-reflection coating onto each of the hard coating activation layers by depositing a layered structure of SiO₂, ZrO₂, ITO, and Al₂O₃ onto each hard coating, as described above. Next, the method may include plasma treating each one, both, or none of the anti-reflection coatings to activate the anti-reflection coatings. Where the anti-reflection coatings are activated, an anti-reflection coating activation layer is formed on the anti-reflection coating. Optionally, hydrophobic coatings are applied to the anti-reflection coatings that were not activated. The hydrophobic coating(s) can be selectively processed upon application to the anti-reflection coating(s). Optionally, anti-fog coatings are applied to the anti-reflection coating activation layers.

Optionally, cleaning the resin lens with ultrasonic waves and drying the resin lens may include placing the resin lens in an oven or heating chamber. Optionally, the oven has a temperature between about 50° C. and about 70° C. Optionally, the resin lens is placed on the oven for a time between about 20 minutes and about 40 minutes. In some embodiments, the oven has a temperature of about 60° C., and the resin lens is dried in the oven for about 30 minutes.

In some embodiments of this method, the resin lens is cooled to room temperature before the hard coating is applied. Furthermore, applying the hard coating can also include applying a hard coating with a narrow-band yellow light absorber, as described above. The narrow-band yellow light absorber can be an organic dye or pigment that is added to the hard coating. Optionally, the hard coating is an organosilicon hardening material.

Optionally, applying the hard coating to the resin lens can include dip coating or spin coating the hard coating to the resin lens. The lifting speed for this step can be between about 0.1 mm/s to 4.0 mm/s or between about 0.5 mm/s and about 3.5 mm/s. In some embodiments, the lifting speed is about 2.0 mm/s. The lifting speed used to apply the hard coating impacts the thickness of the hard coatings. For example, a faster lifting speed yields a thinner hard coating, while a slower lifting speed yields a thicker hard coating.

Some embodiments of the method comprise curing the hard coating after it is applied to the resin lens. This can be done at a temperature of about 118° C. for about 3 hours.

Vacuum coating the anti-reflection coating onto the lenses requires an electron gun power of about 5% and about 55%, a thermal evaporation power of about 5% and about 20%, an anode voltage of about 85 V and about 125 V, an anode current of about 0.5 A and about 4 A, an O₂ flow rate between about 0 sccm and about 35 sccm, and an Ar flow rate of between about 0 sccm and about 55 sccm. Additionally, the vacuum coating chamber has a temperature between about 30° C. and about 60° C. and a pressure between about 31.0×10⁻² Pa and about 1.0×10⁻⁶ Pa. Moreover, the evaporation rates for vacuum coating the anti-reflection layer are between about 0.1 nm/s and about 3.5 nm/s for SiO₂, about 0.05 nm/s and about 2.5 nm/s for ZrO₂, and about 0.05 nm/s and about 0.9 nm/s for Al₂O₃, and about 0.05 nm/s and about 0.8 nm/s for ITO.

Furthermore, activating the anti-reflection coating via plasma treatment requires a power supply between about 400 W and about 1100 W, a treatment time between about 30 seconds and about 15 minutes, an O₂ flow rate between about 1 sccm and about 150 sccm, and an Ar flow rate between about 1 sccm and about 250 sccm.

Some embodiments of the method that include applying a hydrophobic coating to the anti-reflection coating can include plating the hydrophobic coating onto the anti-reflection coating. Optionally, this can include plating an anti-reflection coating with PFAS, as described above.

Some embodiments of the method that include applying the anti-fog coating to the anti-reflection coating activation layer(s) can include dip coating or spray coating the anti-fog coating onto the anti-reflection coating activation layer(s).

In a first example (the first embodiment, shown in FIG. 6), a polyurethane-based, anti-blue light resin lens is cleaned via ultrasound and dried in a 60° C. oven for about 30 minutes. The resin lens is removed from the oven and allowed to cool until it reaches room temperature. Next, a narrow-band yellow light absorber is added to a hard coating. The hard coating is applied to the resin lens by dip coating at a lifting speed of 2.0 mm/s and allowed to cure at 118° C. for about 3 hours. Next, the resin lens with the hard coating is placed in a vacuum coating chamber with a pressure of 1.0×10⁻⁴ Pa. The hard coating is bombarded with ion beams to activate the hard coating. Subsequently, an electron gun is used to plate SiO₂, ZrO₂, SiO₂, ZrO₂, SiO₂, ZrO₂, ITO, Al₂O₃, and SiO₂ in sequence onto the hard coating to form the anti-reflection coating.

The first layer of SiO₂ has a thickness of 95 nm, the first layer of ZrO₂ has a thickness of 15 nm, the second layer of SiO₂ has a thickness of 90 nm, the second layer of ZrO₂ has a thickness of 25 nm, the third layer of SiO₂ has a thickness of 105 nm, the third layer of ZrO₂ has a thickness of 45 nm, the first layer of ITO has a thickness of 18 nm, the first layer of Al₂O₃ has a thickness of 10 nm, and the fourth layer of SiO₂ has a thickness of 155 nm. The electron gun has a power of 20%, a thermal evaporation power of 12%, an anode voltage of 100 V, an anode current of 2 A, an O₂ flow rate of 30 sccm, and an Ar flow rate of 20 sccm. The evaporation rate of the anti-reflection coating is 0.8 nm/s for SiO₂, 1 nm/s for ZrO₂, 0.2 nm/s for ITO, and 0.5 nm/s for Al₂O₃.

After the anti-reflection coating is applied, it is plasma treated to activate the anti-reflection coating. The plasma treatment occurs with a power supply of 800 W, a treatment time of about 1 minute, an Ar flow rate of about 150 sccm, an SiO₂ evaporation rate of about 0.8 nm/s, a ZrO₂ evaporation rate of about 1 nm/s, an ITO evaporation rate of about 0.2 nm/s, and an Al₂O₃ evaporation rate of about 0.5 nm/s.

Next, the anti-fog coating is plated onto the activated anti-reflection coatings. The anti-fog coating is a silicone polymer hydrophilic coating that is dip coated onto the activated anti-reflection coatings. The anti-fog coating has a thickness of 30 nm.

Finally, the entire lens is put into an oven to cure at 50° C. for about 50 minutes.

In a second example (the second embodiment, shown in FIG. 7), a polyurethane-based, anti-blue light resin lens is cleaned via ultrasound and dried in a 60° C. oven for about 30 minutes. The resin lens is removed from the oven and allowed to cool until it reaches room temperature. Next, a narrow-band yellow light absorber is added to a hard coating. The hard coating is applied to the resin lens by dip coating at a lifting speed of 2.0 mm/s and allowed to cure at 118° C. for about 3 hours. Next, the resin lens with the hard coating is placed in a vacuum coating chamber with a pressure of 1.0×10⁻⁵ Pa. The hard coating is bombarded with ion beams to activate the hard coating. Subsequently, an electron gun is used to plate SiO₂, ZrO₂, SiO₂, ZrO₂, SiO₂, ZrO₂, ITO, Al₂O₃, and SiO₂ in sequence onto the hard coating to form the anti-reflection coating.

The first layer of SiO₂ has a thickness of 98 nm, the first layer of ZrO₂ has a thickness of 16 nm, the second layer of SiO₂ has a thickness of 110 nm, the second layer of ZrO₂ has a thickness of 25 nm, the third layer of SiO₂ has a thickness of 100 nm, the third layer of ZrO₂ has a thickness of 50 nm, the first layer of ITO has a thickness of 15 nm, the first layer of Al₂O₃ has a thickness of 7 nm, and the fourth layer of SiO₂ has a thickness of 160 nm. The electron gun has a power of 25%, a thermal evaporation power of 12%, an anode voltage of 105 V, an anode current of 2 A, an O₂ flow rate of 30 sccm, and an Ar flow rate of 20 sccm. The evaporation rate of the anti-reflection coating is 0.8 nm/s for SiO₂, 1 nm/s for ZrO₂, 0.2 nm/s for ITO, and 0.5 nm/s for Al₂O₃.

After the anti-reflection coatings are applied to both sides of the lens, the anti-reflection coating on the front side of the lens is plated with PFAS to form the hydrophobic coating. The anti-reflection coating on the back side of the lens is plasma treated to activate the anti-reflection coating on the back side of the lens. The plasma treatment occurs with a power supply of 800 W, a treatment time of about 2 minutes, an Ar flow rate of about 100 sccm, an SiO₂ evaporation rate of about 0.8 nm/s, a ZrO₂ evaporation rate of about 1 nm/s, an ITO evaporation rate of about 0.2 nm/s, and an Al₂O₃ evaporation rate of about 0.5 nm/s.

Next, the anti-fog coating is plated onto the activated anti-reflection coating.

The anti-fog coating is a silicone polymer hydrophilic coating that is spray coated onto the activated anti-reflection coatings. The anti-fog coating has a thickness of 50 nm.

Finally, the entire lens is put into an oven to cure at 45° C. for about 1 hour.

In a third example (the third embodiment, shown in FIG. 8), a polyurethane-based, anti-blue light resin lens is cleaned via ultrasound and dried in a 60° C. oven for about 30 minutes. The resin lens is removed from the oven and allowed to cool until it reaches room temperature. Next, a narrow-band yellow light absorber is added to a hard coating. The hard coating is applied to the resin lens by dip coating at a lifting speed of 2.0 mm/s and allowed to cure at 118° C. for about 3 hours. Next, the resin lens with the hard coating is placed in a vacuum coating chamber with a pressure of 1.0×10⁻⁵ Pa. The hard coating is bombarded with ion beams to activate the hard coating. Subsequently, an electron gun is used to plate SiO₂, ZrO₂, SiO₂, ZrO₂, SiO₂, ZrO₂, ITO, Al₂O₃, and SiO₂ in sequence onto the hard coating to form the anti-reflection coating.

The first layer of SiO₂ has a thickness of 90 nm, the first layer of ZrO₂ has a thickness of 15 nm, the second layer of SiO₂ has a thickness of 106 nm, the second layer of ZrO₂ has a thickness of 20 nm, the third layer of SiO₂ has a thickness of 100 nm, the third layer of ZrO₂ has a thickness of 50 nm, the first layer of ITO has a thickness of 15 nm, the first layer of Al₂O₃ has a thickness of 10 nm, and the fourth layer of SiO₂ has a thickness of 180 nm. The electron gun has a power of 25%, a thermal evaporation power of 12%, an anode voltage of 105 V, an anode current of 2 A, an O₂ flow rate of 30 sccm, and an Ar flow rate of 20 sccm. The evaporation rate of the anti-reflection coating is 0.8 nm/s for SiO₂, 1 nm/s for ZrO₂, 0.2 nm/s for ITO, and 0.5 nm/s for Al₂O₃.

After the anti-reflection coatings are applied to both sides of the lens, the anti-reflection coating on the back side of the lens is plated with PFAS to form the hydrophobic coating. The anti-reflection coating on the front side of the lens is plasma treated to activate the anti-reflection coating on the front side of the lens. The plasma treatment occurs with a power supply of 800 W, a treatment time of about 2 minutes, an Ar flow rate of about 100 sccm, an SiO₂ evaporation rate of about 1 nm/s, a ZrO₂ evaporation rate of about 1.5 nm/s, an ITO evaporation rate of about 0.2 nm/s, and an Al₂O₃ evaporation rate of about 0.3 nm/s.

Next, the anti-fog coating is plated onto the activated anti-reflection coating. The anti-fog coating is a silicone polymer hydrophilic coating that is spray coated onto the activated anti-reflection coatings. The anti-fog coating has a thickness of 30 nm.

Finally, the entire lens is put into an oven to cure at 50° C. for about 50 minutes.

In a fourth example, a polyurethane-based, anti-blue light resin lens is cleaned via ultrasound and dried in a 60° C. oven for about 30 minutes. The resin lens is removed from the oven and allowed to cool until it reaches room temperature. Next, a narrow-band yellow light absorber is added to a hard coating. The hard coating is applied to the resin lens by dip coating at a lifting speed of 2.0 mm/s and allowed to cure at 118° C. for about 3 hours. Next, the resin lens with the hard coating is placed in a vacuum coating chamber with a pressure of 1.0×10-5 Pa. The hard coating is bombarded with ion beams to activate the hard coating. Subsequently, an electron gun is used to plate SiO₂, ZrO₂, SiO₂, ZrO₂, ITO, Al₂O₃, and SiO₂ in sequence onto the hard coating to form the anti-reflection coating.

The first layer of SiO₂ has a thickness of 120 nm, the first layer of ZrO₂ has a thickness of 30 nm, the second layer of SiO₂ has a thickness of 20 nm, the second layer of ZrO₂ has a thickness of 50 nm, the first layer of ITO has a thickness of 6 nm, the first layer of Al₂O₃ has a thickness of 10 nm, and the third layer of SiO₂ has a thickness of 65 nm. The electron gun has a power of 10%, an anode voltage of 90 V, an anode current of 3 A, an O₂ flow rate of 30 sccm, and an Ar flow rate of 20 sccm. The evaporation rate of the anti-reflection coating is 1 nm/s for SiO₂, 1 nm/s for ZrO₂, 0.2 nm/s for ITO, and 0.5 nm/s for Al₂O₃.

After the anti-reflection coatings are applied to both sides of the lens, the anti-reflection coatings are plated with HT-100 at an evaporation rate of 0.1 nm/s to form the hydrophobic coating. The hydrophobic coating is about 15 nm thick.

In a fifth example, a polyurethane-based, anti-blue light resin lens is cleaned via ultrasound and dried in a 60° C. oven for about 30 minutes. The resin lens is removed from the oven and allowed to cool until it reaches room temperature. Next, an anti-fog coating is dip coated onto the resin lens. The anti-fog coating has a thickness of about 50 nm. The entire lens is then put into an oven to cure at 50° C. for about 1 hour.

The performance test results of each of these five examples as compared to the functional criterion is provided in Table 3.

TABLE 3
Performance Test Results of Examples 1-5

| | | Example | Example | Example | Example | Example |
|---|---|---|---|---|---|---|
| | Criterion | 1 | 2 | 3 | 4 | 5 |
| Drop angle (front surface) | ≤15° | 2.23° | 2.65° | 104° | 102° | 5° |
| Drop angle (back surface) | ≤15° | 3.36° | 105° | 3.19° | 101° | 6° |
| Boiling adhesion | ≥95% | 100% | 100% | 100% | 100% | 90% |
| Transmittance | ≥90% | 91.23% | 92.12% | 91.67% | 95.67% | 87% |
| Anti-fog test (1) | ANSI Z87.1 | OK | OK | OK | NG | OK |
| Anti-fog test (2) | Soak in water for | OK | OK | OK | NG | NG |
| | 1 hour, anti-fog | | | | | |
| | time >8 s | | | | | |
| Falling sand wear resistance | EN-166 | OK | OK | OK | OK | NG |
| Surface hardness | >6 H | 7 H | 7 H | 7 H | 7 H | 1 H |

First, the drop angle indicates [explain based on answers from inventors]. Further, the boiling adhesion is at 100%, which is higher than the conventional boiling adhesion. This means that each of the coatings that make up the blue light blocking, anti-fog lenses adhere together, which results in the lenses being durable and long-lasting. Moreover, the performance test results show that the blue light blocking, anti-fog lenses described herein have a high transmittance of visible light and a good anti-fog effect. Finally, the falling sand wear resistance test results and the surface hardness both indicate that the lenses described herein are durable and resistant to scratching.

### Illustration of Subject Technology as Clauses

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identifications.

Clauses 1-3. In some embodiments (Clause 1), a blue-light limiting, anti-fog lens comprises: a resin lens having a first surface and a second surface opposite the first surface; a hard coating on at least one of the first or second surfaces; a hard coating activation layer on each hard coating; an anti-reflection coating on each hard coating activation layer, wherein the anti-reflection coating is a layered structure including (in order) a first SiO2 layer (about 80-130 nm), a first ZrO2 layer (about 10-25 nm), a second SiO2 layer (about 90-120 nm), a second ZrO2 layer (about 15-35 nm), a third SiO2 layer (about 90-130 nm), a third ZrO2 layer (about 25-55 nm), a first ITO layer (about 10-25 nm), a first Al2O3 layer (about 1-15 nm), and a fourth SiO2 layer (about 135-215 nm); and an anti-reflection coating activation layer on at least one anti-reflection coating. In some embodiments (Clause 2), a blue-light limiting, anti-fog lens comprises: a double-sided resin lens; a hard coating on at least one side of the double-sided resin lens; a hard coating activation layer on each hard coating; an anti-reflection coating on each hard coating activation layer and comprising a layered structure of SiO2, ZrO2, ITO, and Al2O3; and an anti-reflection coating activation layer on at least one anti-reflection coating. In some embodiments (Clause 3), a blue-light limiting, anti-fog lens comprises a layered structure having at least nine individual layers, wherein each layer comprises SiO2, ZrO2, ITO, or Al2O3.

Clauses 4-13. In embodiments of any of Clauses 1-3, the resin lens may comprise an anti-blue light resin lens (Clause 4). In embodiments of any of Clauses 1-4, the resin lens may have a refractive index between about 1.35 and about 1.87 (Clause 5); in embodiments of any of Clauses 1-5, between about 1.41 and about 1.81 (Clause 6); and in embodiments of any of Clauses 1-6, may be about 1.49 (Clause 7). In embodiments of any of Clauses 1-7, the refractive index may be about 1.56 (Clause 8); in embodiments of any of Clauses 1-8, about 1.59 (Clause 9); in embodiments of any of Clauses 1-9, about 1.61 (Clause 10); in embodiments of any of Clauses 1-10, about 1.67 (Clause 11); and in embodiments of any of Clauses 1-11, about 1.74 (Clause 12). In embodiments of any of Clauses 1-12, the resin lens may comprise a slightly yellow tint (Clause 13).

Clauses 14-21. In embodiments of any of Clauses 1-13, the hard coating may be disposed on both the first surface and the second surface (Clause 14). In embodiments of any of Clauses 1-14, the hard coating may have a thickness between about 0.5 μm and about 12 μm (Clause 15); and in embodiments of any of Clauses 1-15, between about 1 μm and about 10 μm (Clause 16). In embodiments of any of Clauses 1-16, the hard coating may comprise a silicone polymer (Clause 17); in embodiments of any of Clauses 1-17, may comprise a wear-resistant material (Clause 18); and in embodiments of any of Clauses 1-18, may comprise a narrow-band yellow light absorber (Clause 19). In embodiments of Clause 19, the narrow-band yellow light absorber can absorb between about 18% and about 17% of yellow light with a wavelength between about 577 nm and about 587 nm (Clause 20) and/or can absorb between about 10% and about 15% of yellow light with a wavelength of about 582 nm (Clause 21).

Clauses 22-27. In embodiments of any of Clauses 1-21, the anti-reflection coating may be configured to reflect blue light with a wavelength up to about 440 nm and about 460 nm (Clause 22); and in embodiments of any of Clauses 1-22, may be configured to reflect blue light with a wavelength up to about 450 nm (Clause 23). In embodiments of any of Clauses 1-23, the layered structure may comprise: a first SiO2 layer about 90-120 nm; a first ZrO₂ layer about 15-20 nm; a second SiO2 layer about 100-110 nm; a second ZrO2 layer about 20-30 nm; a third SiO2 layer about 100-120 nm; a third ZrO2 layer about 30-50 nm; a first ITO layer about 15-20 nm; a first Al2O3 layer about 5-10 nm; and a fourth SiO2 layer about 150-200 nm (Clause 24). In embodiments of any of Clauses 1-24, the layered structure may comprise: first SiO2 about 95 nm; first ZrO2 about 15 nm; second SiO2 about 90 nm; second ZrO2 about 25 nm; third SiO2 about 105 nm; third ZrO2 about 45 nm; first ITO about 18 nm; first Al2O3 about 10 nm; and fourth SiO2 about 155 nm (Clause 25). In embodiments of any of Clauses 1-25, the layered structure may comprise: first SiO2 about 98 nm; first ZrO2 about 16 nm; second SiO2 about 110 nm; second ZrO2 about 25 nm; third SiO2 about 100 nm; third ZrO2 about 50 nm; first ITO about 15 nm; first Al2O3 about 7 nm; and fourth SiO2 about 160 nm (Clause 26). In embodiments of any of Clauses 1-26, the layered structure may comprise: first SiO2 about 90 nm; first ZrO2 about 15 nm; second SiO2 about 106 nm; second ZrO2 about 20 nm; third SiO2 about 100 nm; third ZrO2 about 50 nm; first ITO about 15 nm; first Al2O3 about 10 nm; and fourth SiO2 about 180 nm (Clause 27).

Clauses 28-35. In embodiments of any of Clauses 1-27, a hydrophobic coating may be disposed on the anti-reflection coating that does not have an anti-reflection coating activation layer (Clause 28). In embodiments of Clause 28, the hydrophobic coating may comprise a per- and polyfluoroalkyl substance (PFAS) (Clause 30); the PFAS hydrophobic coating may have a thickness between about 15 nm and about 35 nm (Clause 31), optionally about 30 nm (Clause 32) or about 20 nm (Clause 33). Also in embodiments of Clause 28, the hydrophobic coating may have a thickness between about 5 nm and about 55 nm (Clause 34) and/or between about 10 nm and about 50 nm (Clause 35).

Clauses 29 and 36-44. In embodiments of any of Clauses 1-28, an anti-fog coating may be disposed on each anti-reflection coating activation layer (Clause 29). In embodiments of Clause 29, the anti-fog coating may comprise a silicone polymer hydrophilic coating (Clause 36), and in embodiments of Clause 36, the silicone polymer hydrophilic coating may have a thickness between about 25 nm and about 55 nm (Clause 37), optionally about 30 nm (Clause 38) or about 50 nm (Clause 39). In embodiments of Clause 29, the anti-fog coating may alternatively or additionally comprise a hydrophilic phosphoric acid organic material (Clause 40). In embodiments of Clause 29, the anti-fog coating may have a thickness between about 15 nm and about 85 nm (Clause 41) and/or between about 20 nm and about 80 nm (Clause 42). In embodiments of Clause 29, the anti-fog coating may have a surface hardness of at least 6H (Clause 43) and/or about 7H (Clause 44).

Clauses 45-46. In embodiments of any of Clauses 1-44, the lens may be configured to transmit at least 91% of visible light (Clause 45); and in embodiments of any of Clauses 1-45, to transmit approximately 92% of visible light (Clause 46).

Clauses 47-50. In some embodiments (Clause 47), a method for manufacturing a blue-light limiting, anti-fog lens comprises: providing a resin lens having a first surface and a second surface opposite the first surface; applying a hard coating to at least one of the first or second surfaces; activating each hard coating; plating an anti-reflection coating on each hard coating, wherein the anti-reflection coating is a layered structure comprising a first SiO2 layer, a first ZrO2 layer, a second SiO2 layer, a second ZrO2 layer, a third SiO2 layer, a third ZrO2 layer, a first ITO layer, a first Al2O3 layer, and a fourth SiO2 layer; and plasma treating each anti-reflection coating to activate each anti-reflection coating. In some embodiments (Clause 48), the method further includes cleaning the resin lens with ultrasonic waves; drying the resin lens; placing the resin lens in a vacuum coating chamber; activating each hard coating in the vacuum coating chamber; vacuum coating each hard coating with an anti-reflection coating by bombarding each hard coating with Ar to activate the hard coating and plating the anti-reflection coating using an electron gun (with the same layered structure of first SiO2/first ZrO2/second SiO2/second ZrO2/third SiO2/third ZrO2/first ITO/first Al2O3/fourth SiO2); and plasma treating each anti-reflection coating to activate each anti-reflection coating. In some embodiments (Clause 49), a method comprises: providing a resin lens with first and second surfaces; applying a hard coating to at least one surface; placing the resin lens in a vacuum coating chamber; activating each hard coating in the vacuum coating chamber; vacuum coating each hard coating with an anti-reflection coating by bombarding each hard coating with Ar and plating the anti-reflection coating using an electron gun, wherein the anti-reflection coating is a layered structure comprising: first SiO2 about 50-130 nm, first ZrO2 about 2-70 nm, second SiO2 about 8-115 nm, second ZrO2 about 2-1100 nm, third SiO2 about 2-70 nm, third ZrO2 about 8-115 nm, first ITO about 4-11 nm, first Al2O3 about 4-11 nm, and fourth SiO2 about 50-130 nm; and plasma treating each anti-reflection coating to activate each anti-reflection coating. In some embodiments (Clause 50), a method comprises: providing a double-sided lens; applying a hard coating to at least one side; placing the lens in a vacuum coating chamber; activating each hard coating in the vacuum coating chamber; plating an anti-reflection coating on each hard coating with an electron gun, wherein the anti-reflection coating is a layered structure comprising SiO2, ZrO2, ITO, and Al2O3; and plasma treating each anti-reflection coating to activate each anti-reflection coating.

Clauses 51-65. In embodiments of any of Clauses 47-50, providing the resin lens may comprise providing an anti-blue light resin lens (Clause 51). In embodiments of any of Clauses 47-51, drying may comprise drying the resin lens in an oven at about 60° C. for about 30 minutes (Clause 52), and in embodiments of any of Clauses 47-52, further comprising removing the resin lens from the oven and cooling to room temperature before applying the hard coating (Clause 53). In embodiments of any of Clauses 47-53, applying the hard coating may comprise applying a narrow-band yellow light absorber configured to absorb light with a wavelength between about 577 nm and about 587 nm (Clause 54), and in embodiments of any of Clauses 47-54, configured to absorb light with a wavelength of about 582 nm (Clause 55), wherein applying the narrow-band yellow light absorber may comprise applying an organic dye (Clause 56) and/or an organic pigment (Clause 57). In embodiments of any of Clauses 47-57, applying the hard coating may comprise applying an organosilicon hardening material (Clause 58) and may comprise applying the hard coating to both the first and second surfaces (Clause 59). In embodiments of any of Clauses 47-59, applying the hard coating may comprise dip coating (Clause 60) and/or spin coating (Clause 61), and may comprise coating using a lifting speed between about 0.1 mm/s and 4.0 mm/s (Clause 62), between about 0.5 mm/s and about 3.5 mm/s (Clause 63), and/or about 2.0 mm/s (Clause 64). In embodiments of any of Clauses 47-64, the method may further comprise curing the hard coating at about 118° C. for about 3 hours (Clause 65).

Clauses 66-71. In embodiments of any of Clauses 47-65, placing the resin lens in the vacuum coating chamber may comprise using a chamber temperature between about 30° C. and about 60° C. (Clause 66) and/or between about 35° C. and about 55° C. (Clause 67). In embodiments of any of Clauses 47-67, the chamber pressure may be between about 1.0×10-2 Pa and about 1.0×10-6 Pa (Clause 68), between about 1.0×10-3 Pa and about 1.0×10-5 Pa (Clause 69), and/or about 1.0×10-4 Pa (Clause 70) and/or about 1.0×10-5 Pa (Clause 71).

Clauses 72-84. In embodiments of any of Clauses 47-71, vacuum coating may comprise setting an anode voltage between about 85 V and about 125 V (Clause 72), between about 90 V and about 120 V (Clause 73), and/or about 100 V (Clause 74) and/or about 105 V (Clause 75); and setting an anode current between about 0.5 A and about 4 A (Clause 76), between about 1 A and about 3 A (Clause 77), and/or about 2 A (Clause 78). In embodiments of any of Clauses 47-78, vacuum coating may comprise setting an O2 flow rate between about 0 sccm and about 35 sccm (Clause 79), between about 0 sccm and about 30 sccm (Clause 80), and/or about 30 sccm (Clause 81); and setting an Ar flow rate between about 0 sccm and about 55 sccm (Clause 82), between about 0 sccm and about 50 sccm (Clause 83), and/or about 20 sccm (Clause 84).

Clauses 85-104. In embodiments of any of Clauses 47-84, plating SiO2 may be performed at an evaporation rate between about 0.1 nm/s and about 3.5 nm/s (Clause 85), between about 0.3 nm/s and about 3.0 nm/s (Clause 86), and/or about 0.8 nm/s (Clause 87) and/or about 1.0 nm/s (Clause 88). Plating ZrO2 may be performed at an evaporation rate between about 0.05 nm/s and about 2.5 nm/s (Clause 89), between about 0.1 nm/s and about 2.0 nm/s (Clause 90), and/or about 1.0 nm/s (Clause 91) and/or about 1.5 nm/s (Clause 92). Plating Al2O3 may be performed at an evaporation rate between about 0.05 nm/s and about 0.9 nm/s (Clause 93), between about 0.1 nm/s and about 0.5 nm/s (Clause 94), and/or about 0.3 nm/s (Clause 95) and/or about 0.5 nm/s (Clause 96). Plating ITO may be performed at an evaporation rate between about 0.05 nm/s and about 0.8 nm/s (Clause 97), between about 0.1 nm/s and about 0.3 nm/s (Clause 98), and/or about 0.2 nm/s (Clause 99) and/or about 0.5 nm/s (Clause 100). In embodiments of any of Clauses 47-100, plating with the electron gun may comprise using an electron gun power between about 5% and about 55% (Clause 101), between about 10% and about 50% (Clause 102), and/or about 20% (Clause 103) and/or about 25% (Clause 104).

Clauses 105-120. In embodiments of any of Clauses 47-104, plasma treating each anti-reflection coating may comprise plasma treating with a resistive thermal radiation power between about 5% and about 20% (Clause 105), between about 10% and about 15% (Clause 106), and/or about 12% (Clause 107). Plasma treating may also comprise using a power supply between about 400 W and about 1100 W (Clause 108), between about 500 W and about 1000 W (Clause 109), and/or about 800 W (Clause 110); for a time between about 30 seconds and about 15 minutes (Clause 111), between about 1 minute and about 10 minutes (Clause 112), and/or about 1 minute (Clause 113) and/or about 2 minutes (Clause 114); with an O2 flow rate between about 1 sccm and about 150 sccm (Clause 115) and/or between about 10 sccm and about 100 sccm (Clause 116); and with an Ar flow rate between about 1 sccm and about 250 sccm (Clause 117), between about 10 sccm and about 200 sccm (Clause 118), and/or about 100 sccm (Clause 119) and/or about 150 sccm (Clause 120).

Clauses 121-130. In embodiments of any of Clauses 47-120, the method may further comprise plating at least one anti-reflection coating with a hydrophobic coating (Clause 121), wherein plasma treating to activate may comprise plasma treating the anti-reflection coating that is not plated with the hydrophobic coating (Clause 122), and/or wherein plating at least one anti-reflection coating comprises plating each anti-reflection coating with the hydrophobic coating (Clause 123), optionally by plating PFAS on each anti-reflection coating (Clause 124). In embodiments of any of Clauses 121-124, the method may further comprise coating each anti-reflection coating and each hydrophobic coating with an anti-fog coating (Clause 125), wherein the coating may be applied by dip coating (Clause 126) and/or spray coating (Clause 127). In embodiments of any of Clauses 47-127, the method may alternatively or additionally comprise coating each anti-reflection coating with an anti-fog coating (Clause 128), wherein coating may be by dip coating (Clause 129) and/or spray coating (Clause 130).

Clauses 131-139. In embodiments of any of Clauses 47-130, the method may further comprise curing the lens in an oven (Clause 131), wherein curing temperature may be between about 25° C. and about 65° C. (Clause 132), between about 30° C. and about 60° C. (Clause 133), and/or about 50° C. (Clause 134) and/or about 45° C. (Clause 135); and wherein curing time may be between about 15 minutes and about 65 minutes (Clause 136), between about 20 minutes and about 60 minutes (Clause 137), and/or about 50 minutes (Clause 138) and/or about 60 minutes (Clause 139).

### FURTHER CONSIDERATIONS

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order and are not meant to be limited to the specific order or hierarchy presented.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

As used herein, the term “about” is relative to the actual value stated, as will be appreciated by those of skill in the art, and allows for approximations, inaccuracies and limits of measurement under the relevant circumstances. In one or more aspects, the terms “about,” “substantially,” and “approximately” may provide an industry-accepted tolerance for their corresponding terms and/or relativity between items, such as a tolerance of from less than one percent to 10 percent of the actual value stated, and other suitable tolerances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Although the detailed description contains many specifics, these should not be construed as limiting the scope of the subject technology but merely as illustrating different examples and aspects of the subject technology. It should be appreciated that the scope of the subject technology includes other embodiments not discussed in detail above.

Various other modifications, changes and variations may be made in the arrangement, operation and details of the method and apparatus of the subject technology disclosed herein without departing from the scope of the present disclosure. In addition, it is not necessary for a device or method to address every problem that is solvable (or possess every advantage that is achievable) by different embodiments of the disclosure in order to be encompassed within the scope of the disclosure. The use herein of “can” and derivatives thereof shall be understood in the sense of “possibly” or “optionally” as opposed to an affirmative capability.

What is claimed is:

1. A blue-light limiting, anti-fog lens comprising:
a resin lens comprising a first surface and a second surface opposite the first surface;
a hard coating disposed on at least one of the first surface or the second surface;
an anti-reflection coating disposed over the hard coating, the anti-reflection coating comprising a multilayer stack including at least one SiO2 layer, at least one ZrO2 layer, at least one indium tin oxide (ITO) layer, and at least one Al2O3 layer; and
an anti-fog coating disposed over the anti-reflection coating,
wherein the anti-reflection coating is configured to reflect blue light having a wavelength between about 440 nm and about 460 nm.

2. The lens of claim 1, further comprising:
a hard coating activation layer disposed between the hard coating and the anti-reflection coating; and
an anti-reflection coating activation layer disposed on the anti-reflection coating,
wherein the anti-fog coating is disposed on the anti-reflection coating activation layer.

3. The lens of claim 2, wherein the hard coating, the hard coating activation layer, the anti-reflection coating, and the anti-reflection coating activation layer are disposed on both the first surface and the second surface.

4. The lens of claim 3, wherein the anti-reflection coating comprises a layered structure including, in order away from the hard coating activation layer: a first SiO2 layer, a first ZrO2 layer, a second SiO2 layer, a second ZrO2 layer, a third SiO2 layer, a third Zr2 layer, a first ITO layer, a first Al2O3 layer, and a fourth SiO2 layer.

5. The lens of claim 4, wherein:
the first SiO2 layer has a thickness between about 90 nm and about 120 nm;
the first ZrO2 layer has a thickness between about 15 nm and about 20 nm;
the second SiO2 layer has a thickness between about 100 nm and about 110 nm;
the second ZrO2 layer has a thickness between about 20 nm and about 30 nm;
the third SiO2 layer has a thickness between about 100 nm and about 120 nm;
the third ZrO2 layer has a thickness between about 30 nm and about 50 nm;
the first ITO layer has a thickness between about 15 nm and about 20 nm;
the first Al2O3 layer has a thickness between about 5 nm and about 10 nm; and
the fourth SiO2 layer has a thickness between about 150 nm and about 200 nm.

6. The lens of claim 1, wherein the hard coating comprises a narrow-band yellow light absorber configured to absorb between about 10% and about 15% of yellow light having a wavelength of about 582 nm.

7. The lens of claim 1, wherein the resin lens comprises an anti-blue light resin lens having a refractive index between about 1.35 and about 1.87 and having a slightly yellow tint.

8. A blue-light limiting, anti-fog lens comprising:
a resin lens having first and second opposing surfaces;
a hard coating disposed on each of the first and second opposing surfaces;
a hard coating activation layer disposed on each hard coating;
an anti-reflection coating disposed on each hard coating activation layer, each anti-reflection coating comprising a layered structure including at least one SiO2 layer, at least one ZrO2 layer, at least one indium tin oxide (ITO) layer, and at least one Al2O3 layer;
an anti-reflection coating activation layer disposed on only the anti-reflection coating on the first opposing surface;
an anti-fog coating disposed on the anti-reflection coating activation layer; and
a hydrophobic coating disposed on the anti-reflection coating on the second opposing surface that lacks the anti-reflection coating activation layer,
wherein at least one of the anti-reflection coatings is configured to reflect blue light having a wavelength between about 440 nm and about 460 nm.

9. The lens of claim 8, wherein the hydrophobic coating comprises a per- and polyfluoroalkyl substance (PFAS).

10. The lens of claim 9, wherein the hydrophobic coating has a thickness between about 15 nm and about 35 nm.

11. The lens of claim 8, wherein the anti-fog coating comprises a silicone polymer hydrophilic coating.

12. The lens of claim 11, wherein the anti-fog coating has a thickness between about 25 nm and about 55 nm.

13. The lens of claim 8, wherein the anti-fog coating has a surface hardness of at least 6H.

14. The lens of claim 8, wherein the lens is configured to transmit at least 91% of visible light and has a haze value of less than 2%.

15. A method for manufacturing a blue-light limiting, anti-fog lens, the method comprising:
providing a resin lens having a first surface and a second surface opposite the first surface;
applying a hard coating to at least one of the first surface or the second surface;
activating the hard coating to form a hard coating activation layer;
vacuum depositing an anti-reflection coating on the hard coating activation layer, the anti-reflection coating comprising a multilayer stack including at least one SiO2 layer, at least one ZrO2 layer, at least one indium tin oxide (ITO) layer, and at least one Al2O3 layer;
plasma treating the anti-reflection coating to form an anti-reflection coating activation layer; and
coating an anti-fog coating on the anti-reflection coating activation layer.

16. The method of claim 15, wherein providing the resin lens comprises cleaning the resin lens with ultrasonic waves, drying the resin lens in an oven at about 60° C. for about 30 minutes, and cooling the resin lens to room temperature.

17. The method of claim 15, wherein applying the hard coating comprises dip coating the resin lens at a lifting speed between about 0.1 mm/s and about 4.0 mm/s and curing the hard coating at about 118° C. for about 3 hours.

18. The method of claim 15, wherein vacuum depositing the anti-reflection coating comprises placing the resin lens in a vacuum coating chamber having a temperature between about 30° C. and about 60° C. and a pressure between about 1.0×10−2 Pa and about 1.0×10-6 Pa, bombarding the hard coating with Ar to activate the hard coating, and plating the anti-reflection coating using an electron gun.

19. The method of claim 15, wherein plasma treating comprises plasma treating with a power supply between about 400 W and about 1100 W for a time between about 30 seconds and about 15 minutes.

20. The method of claim 15, further comprising:
depositing the anti-reflection coating on each of the first surface and the second surface;
plasma treating only one of the anti-reflection coatings;
plating a hydrophobic coating on the other anti-reflection coating that is not plasma treated;
coating each anti-reflection coating and the hydrophobic coating with the anti-fog coating by dip coating or spray coating; and
curing the lens in an oven at a temperature between about 25° C. and about 65° C. for a time between about 15 minutes and about 65 minutes.
